(19) United States
(12) Patent Application Publication
(10) Pub. No.: US 2017/0202649 A1
(43) Pub. Date: Jul. 20, 2017

(54) PROVISIONAL PROSTHETIC SYSTEMS AND METHODS OF USING SAME

(71) Applicant: Nobel Biocare Services AG, Kloten (CH)

(72) Inventors: Nicolai Bernhard, Winterthur (CH); Roberto Carretta, Zug (CH); Adrian Haus, Zurich (CH); Stefan Holst, Nuremberg (DE); Steven M. Hurson, Yorba Linda, CA (US); Magnus Person, Thalwil (CH); Jorg Weitzel, Rielasingen-Worblingen (DE)

(21) Appl. No.: 15/328,867

(22) PCT Filed: Jul. 24, 2015
(86) PCT No.: PCT/EP2015/066970

§ 371 Date: Jan. 24, 2017

Related U.S. Application Data
(60) Provisional application No. 62/029,289, filed on Jul. 25, 2014.

(51) Int. Cl. A61C 13/107; A61C 8/00; A61C 1/08

(52) U.S. Cl. CPC A61C 13/0001; A61C 1/084; A61C 8/0001; A61C 8/0057; A61C 8/0062; A61C 8/0089; A61C 8/0068; A61C 8/0066

(57) ABSTRACT

Provisional prosthetic systems and methods of coupling such provisional prosthetic systems to a dental implant are disclosed. The provisional prosthetic system can include at least one dental component having a provisional connection feature and a prosthesis. A clinician can couple the prosthesis to the dental component using a bonding agent. The clinician can then drill a hole through the prosthesis. The hole can be configured to receive a fastener to securely fasten the prosthesis and dental component to the implant.

### INCORPORATION BY REFERENCE TO ANY PRIORITY APPLICATIONS

This application claims the benefit of priority of U.S. Provisional Application No. 62/029,289 filed on Jul. 25, 2014, the entire disclosure of which is incorporated herein by reference.

### BACKGROUND

Field

The present invention relates to prosthetic systems and methods, and more specifically, to dental prosthetic systems and methods.

Description of the Related Art

Dental prosthetic systems can be used to reconstruct defects in a patient's jaw such as missing or misaligned teeth. Dental prosthetic systems can include components such as a dental implant, an intermediary structure such as an abutment, and a prosthesis such as a crown, bridge or a denture.

In one method, a provisional dental prosthetic system can be attached to the patient's jaw prior to fabrication and installation of a more permanent dental prosthetic system. This can provide the patient with an interim prosthetic solution which is directly attached to the patient's jaw. However, such provisional dental prosthetic systems and methods often require use of devices, such as long processing screws, which interfere with the clinician's ability to determine and obtain a proper fit for the prosthesis with respect to opposing dentition. Accordingly, there is a need for further improvement of provisional dental prosthetic systems and methods of attaching provisional prosthetic systems to enhance the clinician's ability to obtain a proper fit for the prosthesis.

### SUMMARY

One aspect of the dental prosthetic systems and methods described herein is the recognition of a need for enhancing the fit of a dental prosthesis with respect to opposing dentition. Provisional dental prosthetic systems are often limited due to the use of other devices, such as long processing screws, which interfere with the ability for a clinician to obtain a proper fit.

In some embodiments, a method of coupling a dental prosthesis to an implant or an abutment can include the step of coupling a coping to the abutment using a snap-fit connection. The method can also include the step of bonding the prosthesis to the coping. The method can also include the step of decoupling the prosthesis and coping from the abutment via the snap-fit connection. The method can also include the step of forming a through-hole in both the coping and the prosthesis. The method can also include the step of coupling the coping and prosthesis to the abutment using a fastener inserted into the through-hole.

In some embodiments, the following features can be combined separately, or together with, the embodiment above. In some embodiments, the step of coupling the prosthesis to the coping can include the step of applying a bonding agent to the coping and to the prosthesis and/or backfilling holes formed in the prosthesis with an acrylic, such as a self-curing acrylic or a light cured composite. This acrylic can be the same material used in forming the prosthesis. In some embodiments, the prosthesis can include one or more blind holes and the step of applying the bonding agent to the prosthesis can include the step of introducing the bonding against into the one or more blind holes and/or backfilling holes formed in the prosthesis with an acrylic, such as a self-curing acrylic or a light cured composite. The method can also include the step of temporarily coupling a coping to the abutment via a provisional connection feature. In some embodiments, the step of temporarily coupling the coping to the abutment via a provisional connection feature can include the step of engaging a snap fit connection feature on the coping with a corresponding snap fit connection feature on the abutment. The method can also include the step of modifying the alignment between the prosthesis and coping and coupling the prosthesis to the coping. In some embodiments, the step of modifying the alignment between the prosthesis and coping can include the step of orienting occlusal surfaces and establishing vertical dimension of the prosthesis with occlusal surfaces of opposing dentition. The method can also include the step of removing the prosthesis and coping from the abutment such that the prosthesis and coping remain in the modified alignment. The method can also include the step of forming a hole through at least the prosthesis using a cutting tool. In some embodiments, the step of forming a hole through at least the prosthesis can include the step of attaching an alignment tool to the coping and using the alignment tool to align the cutting tool with respect to the prosthesis. The method can also include the step of coupling the coping to the abutment via a second connection feature, the second connection feature being different from the provisional connection feature. In some embodiments, the step of coupling the coping to the abutment via a second connection feature can include the step of fastening the coping to the abutment using a threaded fastener. The method can also include the step of determining a preliminary fit of the prosthesis with respect to the coping prior to the step of attaching the prosthesis to the coping. The method can also include the step of modifying the coping to alter the fit of the prosthesis with respect to the coping.

In some embodiments, a method of attaching and aligning a dental prosthesis to an abutment and coping in a patient's jaw can include the step of coupling the coping to the abutment via a provisional connection feature. The method can also include the step of bonding the prosthesis to the coping. The method can also include the step of modifying the alignment between the prosthesis and the coping while the prosthesis is being bonded to the coping. The method can also include the step of removing the prosthesis and coping from the abutment.

In some embodiments, the following features can be combined separately, or together with, the embodiment above. The method can also include the step of forming one or more blind holes in the prosthesis. In some embodiments, the step of bonding the prosthesis to the coping can include the step of bonding the coping within one or more blind holes in the prosthesis. The method can also include forming a hole through the prosthesis using a cutting tool. In some embodiments, the step of forming a hole through the prosthesis can include the step of attaching an alignment tool to the coping and using the alignment tool to align the cutting tool with respect to the prosthesis. The method can also include the step of coupling the coping to the abutment using a threaded fastener. In some embodiments, the step of modifying the alignment between the prosthesis and coping includes the step of placing occlusal surfaces of the prosthesis in contact with occlusal surfaces of opposing dentition.

In certain embodiments, a system for coupling one or more dental components to a dental implant is provided. The system can include at least one dental component comprising a provisional connection feature. In some embodiments, the dental component can comprise an abutment configured to couple with the dental implant via the provisional connection feature. In some such embodiments, the abutment can comprise an abutment integrated with a coping. The provisional connection feature of the abutment can include one or more fingers and/or can include a spring. In some embodiments, the abutment and the implant can be configured to be coupled via a snap-fit and/or via a friction fit.

In various embodiments where the dental components include a coping and an abutment, the coping can be configured to couple with the abutment via the provisional connection feature, or the abutment can be configured to couple with the coping via the provisional connection feature. In some embodiments, the abutment can include a second connection feature. In some such embodiments, the abutment can be configured to be coupled to the implant via the second connection feature. In various embodiments, the provisional connection feature can comprise one or more fingers and/or can comprise a spring. In some embodiments, the coping and the abutment can be configured to be coupled via a snap-fit and/or via a friction fit. The coping can include an elongate member. In some such embodiments, the elongate member can include a plurality of protrusions and slots. The coping can also include a flange. In some such embodiments, the flange can include a plurality of grooves. In some embodiments, the system can further include a cutting tool.

In various embodiments the dental component can include an adapter configured to couple with the dental implant via the provisional connection feature. In various embodiments, the provisional connection feature can comprise one or more fingers and/or can comprise a spring. In some embodiments, the adapter and the implant can be configured to be coupled via a snap-fit and/or via a friction fit. On a side opposite the dental implant, the adapter can be configured to be coupled to one or more other dental components. For example, the one or more other dental components can include at least one of a prosthesis, an abutment, an impression post, or a healing cap. In some embodiments, the one or more dental component can include an angulated screw channel.

In certain embodiments, a method of creating a dental prosthesis configured to be coupled to a dental implant is provided. The method can include coupling one or more dental components to the implant. At least one dental component can have a provisional connection feature. The method can also include bonding the prosthesis to one or more dental components, decoupling the prosthesis and at least one dental component from the implant via the provisional connection feature, and forming a through-hole in both the at least one dental component and the prosthesis. The through-hole can be configured to receive a fastener configured to couple with the prosthesis and the at least one dental component to the dental implant. In various embodiments, forming the through-hole can include forming the through-hole using a cutting tool from a distal side of the at least one dental component. Forming the through-hole can further include forming the through-hole using the cutting tool or another cutting tool from an occlusal side of the prosthesis. In some embodiments, the method can further include coupling the at least one dental component and the prosthesis to the implant using the fastener inserted into the through-hole.

In various embodiments, the provisional connection feature can comprise a snap-fit connection feature and/or a friction fit connection feature. In some embodiments, the at least one dental component can comprise an abutment configured to couple with the implant via the provisional connection feature. In some such embodiments, the abutment can include an abutment integrated with a coping. In some embodiments where the dental components include a coping and an abutment, the coping can be configured to couple with the abutment via the provisional connection feature, or the abutment can be configured to couple with the coping via the provisional connection feature. In some embodiments, the abutment can include a second connection feature. In some such embodiments, the abutment can be configured to be coupled to the implant via the second connection feature.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 illustrates a schematic view of embodiments of an anchoring unit, a coping, and a prosthesis of a prosthetic system.

FIG. 2 illustrates a schematic view of embodiments of a cutting tool, alignment tool, coping, and prosthesis of the system of FIG. 1.

FIG. 3 illustrates a flow diagram of a first method of attaching a provisional prosthetic system.

FIG. 4 illustrates a flow diagram of a second method of attaching a provisional prosthetic system.

FIG. 5 illustrates a front elevation view of another embodiment of a prosthesis of a prosthetic system.

FIG. 6 illustrates a side elevation view of an embodiment of an implant and abutment of a prosthetic system.

FIG. 7A illustrates a cross-sectional view of an embodiment of a coping of a prosthetic system.

FIG. 7B illustrates a top view of an embodiment of a spring element.

FIG. 7C illustrates a top view of another embodiment of a spring element.

FIG. 8 illustrates a cross-sectional view of the prosthesis of FIG. 5, the abutment of FIG. 6, and the coping of FIG. 7.

FIG. 9 illustrates a cross-sectional view of the apparatus of FIG. 8 with a bonding agent.

FIG. 10 illustrates a cross-sectional view of embodiments of an alignment tool and a cutting tool attached to the prosthesis of FIG. 5 and the coping of FIG. 7.

FIG. 11 illustrates a cross-sectional view of the apparatus of FIG. 10 in a second configuration.

FIG. 12 illustrates a cross-sectional view of the apparatus of FIG. 9 attached with a fastener.

FIG. 13 illustrates a side elevation view of another embodiment of an abutment and of a coping.

FIG. 14 illustrates a perspective view of another embodiment of an abutment.

FIG. 15 illustrates a side elevation view of the abutment of FIG. 14.

FIG. 16 illustrates a perspective view of another embodiment of an abutment.

FIG. 17 illustrates a cross-sectional view of the abutment of FIG. 16.

FIG. 18 illustrates a perspective view of another embodiment of a coping.

FIG. 19 illustrates a cross-sectional view of the abutment of FIG. 18.

FIG. 20 illustrates a cross-sectional view of the abutment of FIG. 16 and the coping of FIG. 18 attached together.

FIG. 21 illustrates a side elevation view of an embodiment of a two-piece coping.

FIG. 22 illustrates a cross-sectional view of the two-piece coping of FIG. 21.

FIG. 23 illustrates a cross-sectional view of the two-piece coping of FIG. 21 attached to an embodiment of an abutment and connecting screw.

FIG. 24 illustrates a side elevation view of another embodiment of a two-piece coping.

FIG. 25 illustrates a cross-sectional view of the two-piece coping of FIG. 24.

FIG. 26 illustrates a cross-sectional view of the two-piece coping of FIG. 24 attached to an embodiment of an abutment and connecting screw

FIG. 27A illustrates a perspective view of another embodiment of an abutment.

FIG. 27B illustrates a cross-sectional view of the abutment of FIG. 27A.

FIGS. 27C-27E illustrate perspective views of other embodiments of an abutment.

FIG. 28A illustrates a perspective view of another embodiment of an abutment.

FIG. 28B illustrates a cross-sectional view of the abutment of FIG. 28A.

FIG. 29A illustrates a perspective view of another embodiment of an abutment.

FIG. 29B illustrates a cross-sectional view of the abutment of FIG. 29A.

FIG. 30A illustrates a perspective view of another embodiment of a coping.

FIG. 30B illustrates a cross-sectional view of the coping of FIG. 30A.

FIG. 31 illustrates a perspective view of an example abutment configured to mate with the coping of FIGS. 30A and 30B.

FIG. 32A-32D illustrate an example embodiment of a method of coupling a provisional prosthetic system.

FIG. 33A illustrates a perspective view of an embodiment of an adapter.

FIG. 33B illustrates a perspective view of another embodiment of an adapter.

FIGS. 34-36 illustrate example components that can be coupled to an adapter.

### DETAILED DESCRIPTION

Embodiments of a prosthetic system and method will now be described with reference to the accompanying figures, wherein like numerals refer to like or similar elements throughout. Although several embodiments, examples and illustrations are disclosed below, it will be understood by those of ordinary skill in the art that the inventions described herein extends beyond the specifically disclosed embodiments, examples and illustrations, and can include other uses of the inventions and obvious modifications and equivalents thereof. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Certain terminology may be used in the following description for the purpose of reference only, and thus are not intended to be limiting. For example, terms such as “above” and “below” refer to directions in the drawings to which reference is made. Terms such as “proximal,” “distal,” “front,” “back,” “rear,” and “side” describe the orientation and/or location of portions of the components or elements within a consistent but arbitrary frame of reference which is made clear by reference to the text and the associated drawings describing the components or elements under discussion. Such terminology may include the words specifically mentioned above, derivatives thereof, and words of similar import.

As used herein, the term “proximal” refers to the parts of the device and system which are located closer to the operator of the device and system (e.g., clinician) and generally would refer to parts of the device and system located further from the implantation location of the device and system. The term “distal” refers to the parts of the device and system which are located further from the operator of the device and system (e.g., clinician) and generally would refer to parts of the device and system located closer to the implantation location of the device and system.

As will be described, certain embodiments relate to a maxillofacial prosthesis system and methods of using the system. More specifically, one embodiment is directed to a provisional dental prosthetic system and methods of attaching a provisional dental prosthetic system to a patient. The present systems and methods can be used, for example, within days after dental implants have been affixed into a patient's jaw and before a permanent prosthetic solution has been fabricated and installed. In some instances, the present systems and methods can be used immediately after dental implants have been affixed to the patient's jaw. Accordingly, the patient can be provided with an attachable prosthesis during the healing period and prior to full osseointegration of the implant.

However, it should be appreciated that while, in some instances, the figures and description herein refer to a provisional dental prosthesis in the form of a full bridge for placement along the maxillary and/or mandibular arches, in modified embodiments, the prosthesis can be any type of prosthesis including, but not limited to, partial bridges and crowns. It should also be appreciated that while, in some instances, the figures and description herein refer to a provisional dental prosthesis in the form of a single tooth crown, in modified embodiments, the prosthesis can be any type of prosthesis including, but not limited to, partial and full bridges. In other words, various features described herein can be used for either single tooth or multi-tooth restorations. In addition, while in some examples, various features are described and shown associated with an illustrated dental component (e.g., a coping), in modified embodiments, those features can be associated with any type of dental component (e.g., an abutment, an implant, etc.). Furthermore, it should be appreciated that the systems and methods described herein are at times described as being provisional in nature, such systems and methods can also be applied to the fabrication and attachment of permanent prosthetic solutions.

### Provisional Dental Prosthesis and Attachment System

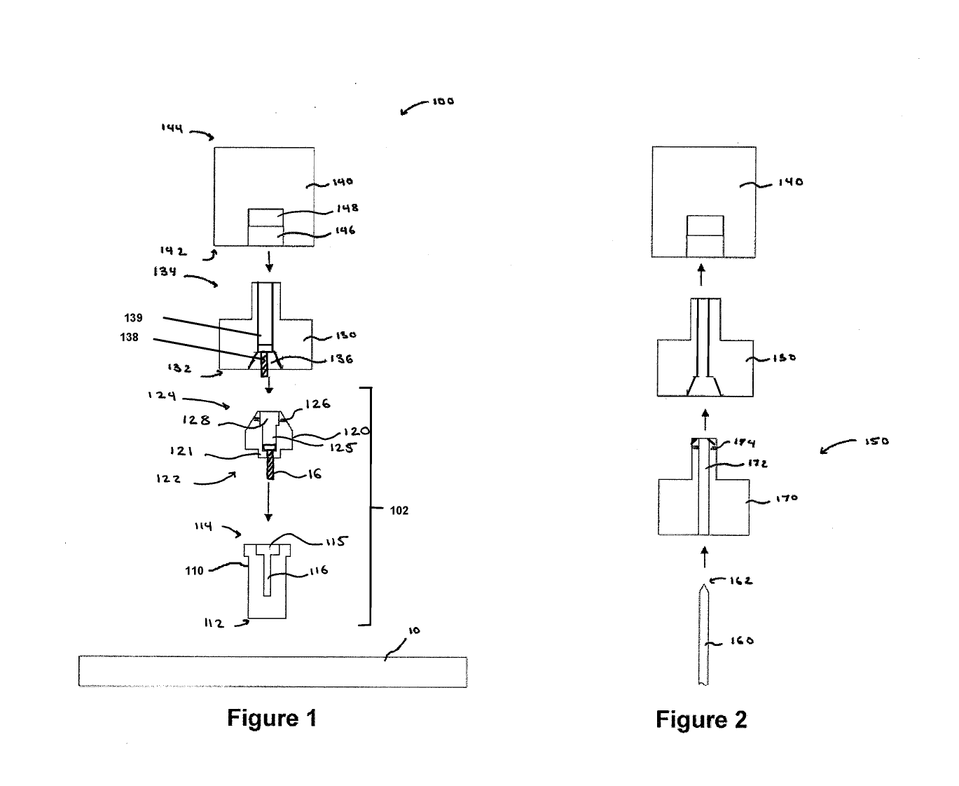

With reference now to FIG. 1, an embodiment of a dental prosthesis and attachment system 100 is schematically illustrated. The system 100 can include an anchoring unit 102 for coupling to a patient's bone 10, as well as a coping 130, and a prosthesis 140. As will be explained below, the coping 130 can be coupled to the anchoring unit 102 and the prosthesis 140 can be coupled to the coping 130. In some embodiments, the anchoring unit 102 can include a bone implant 110, such as a dental implant, and an abutment 120, such as a multi-unit abutment. In the illustrated arrangement, the abutment 120 can be removably coupled to the bone implant 110 via a coupling screw 16. In some embodiments, the implant 110 and the abutment 120 can form an integral unit. Furthermore, it should be understood that certain components of the anchoring unit 102 can be omitted. For example, in some embodiments, the abutment 120 can be omitted from the anchoring unit 102 such that the coping 130 is instead directly attached to the implant 110. As another example, in some embodiments, the coping 130 and abutment 120 can form an integral unit such that the combined coping 130/abutment 120 is directly attached to the implant 110. In some such instances, the combined coping 130/abutment 120 can sometimes be referred to simply as the coping 130 or simply as the abutment 120. In other arrangements, the coupling screw 16 can be omitted and the abutment 120 can include a threaded end that is inserted into the implant 110

As will be described in further detail below, certain of the connection features used to attach the various components together can be designed to facilitate removal of the components from each other. In some embodiments, the connection features form “snap-fit” connections which include, but is not limited to springs, clips, resilient dimples or bosses, can be used to facilitate coupling and then removal of components from each other. For example, the coping 130 can be coupled to the abutment 120 using a “snap-fit” connection. Accordingly, in some embodiments, the coping 130 can be initially coupled to the abutment 120 by a “snap-fit” and then removed from the abutment 120 by applying a separation force in a direction away from the abutment 120 that exceeds the snap-fit. As another example, the coping 130, the abutment 120, or the combined coping 130/abutment 120 can be coupled directly to the implant 110 using a “snap-fit” connection. Accordingly, in some embodiments, the coping 130, the abutment 120, or the combined coping 130/abutment 120 can be initially coupled to the implant 110 by a “snap-fit” and then removed from the implant 110 by applying a separation force in a direction away from the implant that exceeds the “snap-fit.”

However, in other embodiments, other types of provisional connection features can also be used, for example, including a retention collar or other feature which can be tightened to create a friction fit between the components, adhesives between the two components, and the like. In some embodiments, a portion of a dental component can press against a surface of another dental component creating a friction fit or interference fit. In some such embodiments, a distal portion of a first dental component can create a friction fit with a proximal portion of a second dental component. The first dental component can include a coping 130 and the second dental component can include an abutment 120. As another example, the first and second dental components can include two portions of a multi-unit abutment. As yet another example, the first dental component can include a coping 130, an abutment 120, or a combined coping 130/abutment 120 and the second dental component can include an implant 110. In some instances, the distal portion of the first dental component can include a portion of an exterior surface, and the proximal portion of the second dental component can include an interior surface (e.g., an inner wall of a recess, bore, or cavity). In some other instances, the distal portion of the first dental component can include a portion of an interior surface (e.g., an inner wall of recess, bore, or cavity), and the proximal portion of the second dental component can include an exterior surface. In some embodiments, a friction fit or an adhesive can provide a sufficient initial holding force such that the two components retain their positioning and orientation upon application of a force below a threshold value but are removable once a threshold, separating force has been applied to the two components. Generally, the threshold force required to overcome the provisional connection feature and detach the components should be chosen such that injury to the patient's bone is avoided. This is particularly important in cases of provisional prosthetic systems in which the prosthetic system is being attached immediately or shortly after surgical implantation of the implants 110.

With continued reference to FIG. 1, as noted above, the system 100 can include one or more implants 110 (e.g., a dental implant) for affixing into a patient's bone 10. In some embodiments, the implant 110 can have a monolithic structure with a distal end 112 designed to be placed within and osseointegrated with a patient's jaw and a proximal end 114 designed to allow attachment of another dental component such as the abutment 120 (or the coping 130 or the combined coping 130/abutment 120). In some embodiments, the one or more implants 110 can be placed at multiple implantation locations within the patient's jaw based on factors such as the nature of the permanent prosthesis to be fitted to the patient upon complete osseointegration of the implants 110 as well as the patient's bone structure. In some embodiments, a single implant 110 can be used when the patient is being fitted with a crown (i.e., a prosthesis having a single tooth). In other embodiments, two or more implants 110 can be used when the patient is being fitted with a partial or full bridge (i.e., a prosthesis having multiple teeth). For example, in some surgical procedures, four implants 110 can be used for attaching a full bridge dental prosthesis. Such a technique can be used, for example, as part of Nobel Biocare's All-On-4® surgical procedure. Of course, it should be understood that in some surgical procedures, it may be deemed by the clinician that no anchoring units 102 are needed and thus the implants 110 can be omitted entirely from the system 100. Such may be the case, for example, when the patient's existing teeth are deemed sufficient to retain the prosthesis.

For affixing the implant 110 to bone 10, the implant 110 can include threading or similar features along at least a portion of the exterior surface. In some embodiments, the implant 110 can include threading at least partially along the exterior surface adjacent the bone 10 when the implant 110 is placed within the implantation location. For example, threading can be included at least partially along exterior surfaces proximate the distal end 112 of the implant 110. Of course, it should be understood that threading or similar features can extend towards the proximal end 114 of the implant 110 or be located primarily at the proximal end 114.

For attachment to other dental components, such as abutment 120 (or coping 130 or combined coping 130/abutment 120), the implant 110 can include one or more connection features designed to interact with a corresponding connection feature on the other dental component. In some embodiments, the implant 110 can include one or more internal connection elements such as bores or cavities sized and shaped to at least partially receive a portion of the abutment 120 and/or fasteners. For example, as shown in the illustrated embodiment, the implant 110 can include a threaded bore 116 into which a threaded screw, such as coupling screw 16, can be attached. In addition, the implant 110 can include an alignment feature 115 which can comprise internal lobes or an internal hex which correspond to external lobes or an external hex on an abutment 120. The bore 116 of the implant 110 can also include additional elements e.g., a tapered connection portion or less elements. In other embodiments, the implant 110 can include external features (e.g., such as external lobes or an external hex) that can be received within a corresponding recess within the abutment 120. In some embodiments, the alignment feature 115 can be located at or proximate the proximal end 114 of the implant 110. The alignment feature 115 can have an aperture located along a proximal surface of the implant 110 for allowing entry of the dental component into the alignment feature 115 and the threaded bore 116.

In some embodiments, the implant 110 can include additional features for facilitating and enhancing the connection between the implant 110 and the dental component. For example, the implant 110 can include grooves, dimples, roughening, or the like to enhance the connection with the dental component. As another example, the implant 110 can include other keyed features for ensuring that the dental component cannot rotate with respect to the implant 110. Such keyed components can include providing the bore with a specific cross-sectional shape or by adding slots, channels, protrusions or other structure which allow insertion of a dental component in a select number of orientations. Furthermore, the implant 110 can include other connection features to positively engage the dental component and reduce the likelihood that the component becomes inadvertently detached from the implant 110. For example, the implant 110 can include a “snap-fit” connector for positively engaging a corresponding “snap-fit” connector of the dental component. Such features can be located, for example, on the interior surfaces, exterior surfaces, or both of the implant 110.

With continued reference to FIG. 1, as noted above, the system 100 can include one or more abutments 120 for attachment to one or more other dental components. For example, the abutment 120 can be a multi-unit abutment that is coupled to the implant 110 with a coupling screw 16 that passes through an internal bore 125 and engages threading on the threaded bore 116 of the implant 110. In some embodiments, the abutment 120 can have a monolithic structure with a distal end 122 designed to be inserted into the implant 110 and a proximal end 124 designed to allow attachment to another dental component, such as the coping 130. Of course, it should be appreciated that the abutment 120 can also be formed from two or more sub-components. For example, the abutment 120 can have a distal sub-component forming the distal end 122 for attachment to the implant 110 and a proximal sub-component forming the proximal end 124 for attachment to another dental component. The proximal and distal sub-components can be attached together to form the abutment 120.

For attachment to a dental component, such as implant 110, the abutment 120 can include one or more corresponding connection features to attach to the implant 110 and reduce the likelihood of inadvertent removal. As described above, in some embodiments, the abutment 120 can be attached to the implant 110 using a coupling screw 16. In some embodiments, the abutment 120 can include threading at least partially along an exterior surface of the distal end 122 such that the abutment 120 can engage corresponding threading of the implant 110. In some embodiments, the abutment 120 can include resiliently deformable members which are received into a corresponding connection feature in the implant 110 which can advantageously provide a “snap-fit” and/or friction fit connection. Other types of connection features, such as a bayonet mounting structure, can also be used. It should be understood that such connection features can also be included along interior surfaces of the abutment 120 if the abutment 120 has a bore or cavity.

To facilitate alignment of the abutment 120 with respect to the implant 110, the abutment 120 can include keyed features which correspond to keyed features of the implant 110. For example, at least a portion of the abutment 120 can have a non-circular cross-section which corresponds to a non-circular cross-section of the bore of the implant 110. For example, the abutment 120 can include an alignment feature 121 which corresponds with the alignment feature 115 of the implant 110. For example, the alignment feature 115 can have a plurality of external lobes or an external hex-shape. In some embodiments, the abutment 120 can include slots, grooves, or other protrusions which align with corresponding slots, grooves, or protrusions on the implant 110 to ensure proper alignment prior to fastening.

For attachment to other dental components, such as coping 130 and/or to a dental component such as, for example, a dental restoration or dental restoration component such as, for example, a multi-unit bridge and/or restoration, in some embodiments the abutment 120 can include one or more provisional connection features 126 designed to interact with a corresponding provisional connection feature on the other dental component. For example, in some embodiments, the abutment 120 can include a slot or protrusion positioned along an exterior surface configured to engage a corresponding protrusion or slot on the other dental component. Accordingly, the provisional connection feature 126 can be positioned at or proximate the proximal end 124 of the abutment 120. As discussed above, in one embodiment, the provisional connection feature 126 can be designed to allow for a “snap-fit” and or a friction fit connection between the abutment 120 and the other dental component such as the coping 130 thereby advantageously allowing the abutment 120 and the other dental component (e.g., coping 130) to be easily removed via application of a separation force. As will be made apparent through the course of this disclosure, the ability to easily remove the dental component from the abutment 120 can facilitate preparation of the provisional prosthesis system 100 for final installation to the patient's jaw.

It should be appreciated that, in some embodiments, the provisional connection feature 126 can be included on an interior surface of the abutment 120. For example, the provisional connection feature 126 can be located either entirely or partially along an interior surface of a bore, such as bore 125, of the abutment 120. Moreover, in some embodiments, the provisional connection feature 126 can be an adhesive component disposed on the component 120. Such adhesive can be chosen to sever upon application of a threshold separation force.

In some embodiments, the abutment 120 can include connection features designed to interact with a corresponding connection feature on the other dental component, such as coping 130. As shown in the illustrated embodiment, the connection feature can be an internally threaded bore 128. The internally threaded bore 128 can engage a prosthesis screw used to couple the coping 130 to the abutment 120. In some embodiments, the internally threaded bore 128 can be located at or proximate the proximal end 124 of the abutment 120. The bore can have an aperture located along a proximal surface of the first abutment 120 for allowing entry of the dental component, a separate fastener, or both into the bore 128. Although the bore 128 is illustrated as having a greater diameter than that bore 125, it should be understood that the bore 128 can have the same diameter as bore 125. Moreover, while the bore 128 is illustrated as being coaxial with bore 125, it should be understood that the two bores 125, 128 can be non-coaxial. In some embodiments, the connection feature can be located along an exterior surface of the abutment 120. However, it should be understood that connection feature can be omitted. For example, in some embodiments, a prosthetic screw used to couple the coping 130 to the abutment 120 can engage internal threading on the coupling screw 16 itself if such internal threading is provided.

With continued reference to FIG. 1, the system 100 can include one or more copings 130 for attachment to one or more dental components. In some embodiments, the coping 130 can have a monolithic structure with a distal end 132 designed to be attached to a dental component, such as abutment 120 or implant 110, and a proximal end 134 designed to allow attachment of another dental component such as the provisional prosthesis 140.

For attachment to a dental component, such as abutment 120, the coping 130 can include one or more connection features designed to interact with a corresponding connection feature, such as provisional connection feature 126, on the abutment 120. In some embodiments, the coping 130 can include a cavity 136 or bore sized and shaped to at least partially receive a portion of the abutment 120 which includes a connection feature along an interior surface to engage provisional connection feature 126. In some embodiments, the cavity 136 can be located at or proximate the distal end 132 of the coping 130 and can have an aperture located along a distal surface of the coping 130 for allowing entry of the dental component into the cavity 136.

The connection feature can include an annular protrusion or annular slot positioned along interior surfaces, such as an interior surface of cavity 136, configured to engage a corresponding feature, such as provisional connection feature 126, on the abutment 120. Accordingly, in some embodiments, both the coping 130 and the abutment 120 can be retained using a “snap-fit” and/or friction fit connection. This can advantageously allow the coping 130 and the abutment 120 to be easily removed. Other types of connection features, such as a bayonet mounting structure, can also be used. Moreover, in some embodiments, the connection feature can be an adhesive component disposed on the coping 130. Such adhesive can be chosen to sever upon application of a threshold separation force. It should be appreciated that connection features can also be included along exterior surfaces of the coping 130.

In some embodiments, the coping 130 can include features for facilitating and enhancing the connection between the coping 130 and the abutment 120. For example, to facilitate alignment of the coping 130 with respect to the abutment 120, the coping 130 can include keyed features which correspond to keyed features of the abutment 120. For example, at least a portion of the cavity 136 of the coping 130 can have a non-circular cross-section which corresponds to a non-circular cross-section of the abutment 120. In some embodiments, the coping 130 can include slots, grooves, or other protrusions which align with corresponding slots, grooves, or protrusions on the abutment 120. Such features can be located, for example, on the interior surfaces, exterior surfaces, or both of the coping 130. For example, such features can be located along an inner surface of the cavity 136.

In some embodiments, the coping 130 can include additional connection features to reduce the likelihood of inadvertent detachment of the coping 130 from the abutment 120. For example, in some embodiments, the coping 130 and the abutment 120 can be attached using a separate fastener such as a prosthetic screw 138. The prosthetic screw 138 can pass through a bore 139 of the coping 130 and positively engage a connection feature of the abutment 120, such as threaded bore 128, or of the coupling screw 16 thereby securely attaching the coping 130 to the abutment 120. This can advantageously further reduce the likelihood of inadvertent detachment of the coping 130 from the abutment. It should be noted that, in some embodiments, the bore 139 is not preliminarily included on the coping 130 but can be formed at a later time.

For attachment to other dental components, the coping 130 can include corresponding connection features to attach to other dental components and reduce the likelihood of inadvertent removal. In some embodiments, the coping 130 can include ridges, protrusions or other features for positively engaging corresponding features on the other dental component.

With continued reference to FIG. 1, the system 100 can include one or more provisional prostheses 140 for attachment to a dental component. In some embodiments, the provisional prosthesis 140 can have a monolithic structure with a distal end 142 designed to be attached to a dental component, such as the coping 130 (or a combined coping 130/abutment 120 or abutment 120), and a proximal end 134 designed to contact opposing dentition.

For attachment to the coping 130, the provisional prosthesis 140 can include one or more connection features designed to interact with a corresponding connection feature on the coping 130. In some embodiments, the provisional prosthesis 140 can include a cavity 146 or bore sized and shaped to at least partially receive a portion of the coping 130. In some embodiments, the cavity 146 can be located at or proximate the distal end 142 of the provisional prosthesis 140. The cavity 146 can have an aperture located along a distal surface of the provisional prosthesis 140 for allowing entry of the coping 130 into the bore. In some embodiments, the cavity 146 can include a connection feature for facilitating and enhancing the connection between the provisional prosthesis 140 and the coping 130. For example, the bore can include a bonding agent 148 which can be used to bond the provisional prosthesis 140 to the coping 130. Such bonding agents 148 can include self-curing, light-curing or other bonding agents which can convert from a relatively low viscosity fluid to a high viscosity fluid or solid. In some embodiments, the bore can be backfilled with an acrylic, such as a self-curing acrylic or a light cured composite. This acrylic can be the same material used in forming the prosthesis. Other types of connection features can also be used including separate fasteners, such as threaded screws or bolts, resiliently deformable members for creating a “snap-fit” or friction fit between the two components, and threading, such as threading along the internal surfaces, of the provisional prosthesis 140.

With reference now to FIG. 2, a cutting system 150 is illustrated which can include a cutting tool 160 and an alignment tool 170. The cutting system 150 can form part of the provisional prosthetic system 100. As shown in the illustrated embodiment, the alignment tool 170 can be attached to the coping 130. However, in some embodiments, the alignment tool 170 might not be used.

The cutting tool 160 can be an elongate member having cutting surfaces located along the outer surfaces of the tool 160. In some embodiments, the cutting tool 160 can have a pointed tip 162 to facilitate cutting in a longitudinal direction when the cutting tool 160 is moved along a longitudinal axis of the tool 160. Accordingly, in some embodiments, the cutting tool 160 can be a drill bit having a circular cross-section. The cutting tool 160 can advantageously be used to create a bore through dental components of the provisional prosthetic system 100 such as the coping 130 and the provisional prosthesis 140.

In some embodiments, an alignment tool 170 can be provided for facilitating the creation of a bore through the dental components. Accordingly, the alignment tool 170 can include an alignment feature 172, such as an alignment bore, through which the cutting tool 160 can pass. In some embodiments, the alignment bore can have a cross-sectional area that is slightly greater than that of the cutting tool 160. This can advantageously allow the cutting tool 160 to pass through the bore without contacting the sides of the bore. Of course, the bore can have a cross-sectional area that is about equal to the cross-sectional area of the cutting tool 160. This can advantageously reduce the amount of play between the cutting tool 160 and the alignment tool 170 thereby enhancing the alignment function of the cutting tool 160. It should be understood that the bore need not have a constant cross-sectional area. In some embodiments, only portions of the bore can be used for alignment of the cutting tool 160. Furthermore, the bore can include additional features for facilitating use of the alignment tool 170 such as tapering along the entry of the alignment bore to facilitate insertion of the cutting tool 160 into the alignment bore.

Furthermore, it should be understood that the bore can be oriented and positioned at various locations within the alignment tool 170 depending on the specific alignment required. For example, in some embodiments, the alignment tool can be used for creating a bore (not shown) through the coping 130 and the provisional prosthesis 140 which is aligned, or at least provides access to, a connection feature, such as threaded bore 128, of the component 120. In some embodiments, after the bore through the prosthesis 140 is created from the coping 130 side (e.g., from the distal side of the coping 130), the cutting tool 160 or another cutting tool (e.g., a cutting tool with a larger diameter than the diameter of cutting tool 160) can also reinforce and/or enlargen the bore by entering from the prosthesis 140 side (e.g., from the proximal or occlusal side of the prosthesis 140). The bore through the coping 130 and prosthesis 140 can subsequently be used to allow a fastener, such as a threaded screw or bolt, to pass therethrough and engage a connection feature of the abutment 120 or implant 110.

In some embodiments, the alignment tool 170 can be designed to be attached to the coping 130 and the provisional prosthesis 140. Accordingly, the alignment tool 170 can include a connection feature 174 designed to interact with a corresponding connection feature on the other dental component. For example, in some embodiments, the alignment tool 170 can include an annular slot or annular protrusion positioned along an exterior surface configured to engage a corresponding feature on the other dental component. In some embodiments, the connection feature 176 can be similar to provisional connection feature 126 of the abutment 120. The connection feature 176 can be designed to allow for a “snap-fit” and/or friction fit connection between the alignment tool 170 and the coping 130. This can advantageously allow the alignment tool 170 and the other dental component to be easily removed after the cutting operation has been completed. It should be appreciated that connection feature 176 can be any type of connection feature as herein described and can be included on exterior surfaces, interior surfaces, or both of the alignment tool 170.

The components of the system 100 can be manufactured from a variety of different materials such as, but not limited to, metals including titanium, cobalt chromium alloy, shape-memory alloys, polymers including acrylics, ceramics including zirconia, composite materials, and/or any other material as desired. For example, in some embodiments, the system 100 can include a cage constructed of a material which can have different characteristics when subject to heat. For example, the material can have a relatively rigid structure at ambient temperatures whereas the material can have a flexible or relaxed structure when subject to slightly elevated temperatures. While at ambient temperature, the cage can be used to couple two separate components together. For example, the cage can be placed inside the coping 130 to couple with the provisional connection feature 126 of the abutment 120. To remove the coping from the abutment, the cage can be heated such that the cage has a relatively relaxed structure thereby facilitating decoupling of the coping from the abutment.

### Methods of Attaching a Provisional Dental Prosthesis System

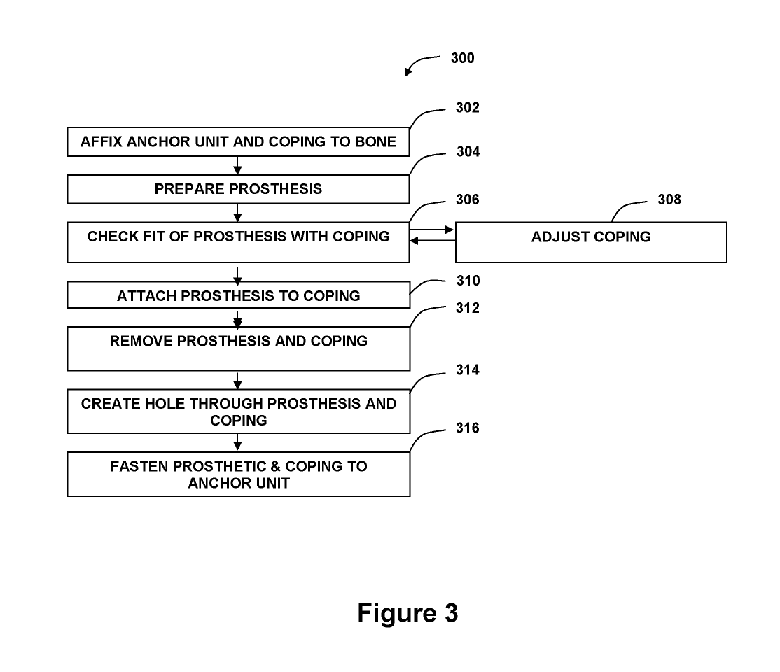

FIG. 3 illustrates a flowchart describing steps of a method 300 for attaching a provisional dental prosthetic system such as the provisional dental prosthetic system 100. For purposes of clarity, the steps are described as being performed by a clinician; however, it should be understood that some or all of the steps of this procedure can be performed by others such as, but not limited to, the clinician's assistants and other third-parties. Moreover, some or all of the steps described herein can be performed either in situ (i.e., in the patient's mouth) or ex situ. For example, some or all of the steps described herein can be performed on a molding of the patient's teeth.

As shown in step 302, a clinician can affix attachment mechanisms to the patient's jaw for allowing the installation of additional dental components. Accordingly, during this step, the clinician can affix one or more anchoring units, such as anchoring unit 102, to the patient's jaw. The clinician can also affix any additional dental components including a coping, such as the coping 130, during this step. Depending on the nature of the procedure such as the patient's condition, the remainder of the method 300 can either be performed immediately after or shortly after this step.

As shown in step 304, the clinician can then prepare a prosthesis, such as provisional prosthesis 140, for attachment to the anchoring unit and the coping. In some procedures, the prosthesis can be prepared chairside. That is, the clinician and/or the clinician's assistants can prepare the prosthesis during the course of the operation. For example, the clinician and/or the clinician's assistants can take the patient's existing prosthesis, such as a removable partial or full denture, and create one or more blind holes opposite the occlusal surfaces of the prosthesis. These blind holes can be aligned such that the prosthesis would generally be properly oriented within the patient's mouth upon completion of the method 300. Furthermore, the blind holes can be formed with a cross-sectional area slightly greater than the cross-sectional area of the coping and/or anchoring unit to permit some degree of play between the blind hole and the coping and/or anchoring unit. Use of an existing prosthesis can advantageously reduce overall complexity and costs of the procedure as modification of an existing prosthesis can be performed within a short span of time. In some instances, this procedure can be performed during a single sitting.

Of course, in some procedures, a new prosthesis can be fabricated in lieu of using the existing prosthesis. In some procedures, the new prosthesis can be prepared with the one or more blind holes already incorporated into the prosthesis. This method can be employed advantageously in situations where the clinician already knows the general placement and orientation of the implants. For example, the new prosthesis can be fabricated in advance of the operation based upon the clinician's planned placement of the implants. Accordingly, the prosthesis can be fabricated prior to the operation thereby allowing the prosthesis to be advantageously attached during a single sitting. In some embodiments, the new prosthesis can be fabricated after the implants have already been affixed to the patient's jaw such that the clinician can better judge the placement of the implants. In other procedures, the new prosthesis can be prepared without blind holes so that the clinician can create such holes as the clinician deems necessary. It should be understood that, while reference is made to the creation of blind holes in the prosthesis, other types of holes such as through-holes can also be included on the prosthesis.

As shown in step 306, the clinician can test the prosthesis for preliminary fit by seating the prosthesis on the anchoring unit, the coping, or a combination of both. During this step, the clinician can place the prosthesis over the anchoring units and copings such that at least the copings are received within one or more blind holes of the prosthesis. Upon placement of the prosthesis over the anchoring units and copings, the clinician can check to see whether the prosthesis is generally aligned with respect to the patient's jaw and opposing dentition. For example, the clinician can determine whether the occlusal surfaces are generally aligned and whether the patient's nose, lips and chin are generally aligned.

The clinician can also determine whether the vertical dimension of occlusion (VDO) and/or vertical dimension at rest (VDR) is properly chosen. The VDO indicates the superior-inferior relationship between the maxilla and mandible when the teeth are in maximum intercuspation. Accordingly, particularly for patients who are fully and/or partially edentulous and thus lack the teeth to position in maximum intercuspation, the clinician can perform one or more tests to determine a proper VDO and/or VDR. For example, the clinician can view the overall appearance of the patient when the prosthesis is seated on the coping to determine whether the patient's nose, lips and chin appear to be in an ordinary configuration of the average person. The clinician can also determine a proper VDO and/or VDR by listening to the patient's pronunciation of certain words. The clinician can take any number of steps to ensure that a proper VDO and/or VDR will be established upon the prosthesis being seated on the copings. For example, to increase the distance between the prosthesis and the coping, the clinician can add pads to either the coping and/or the prosthesis. To decrease the distance between the prosthesis and the coping, the clinician can trim down the top most portion of the coping and/or drill a longer blind hole through the prosthesis.

The clinician can check to see whether only minor adjustments would be needed to place the prosthesis in proper alignment and achieve a proper VDO and/or VDR. Preferably, the adjustments should be sufficiently aligned such that any remaining adjustments made during the attachment step 310 can take place by placing the patient's teeth in a centric occlusion to mate the occlusal surfaces of the prosthesis to the opposing dentition.

Should the clinician determine that the prosthesis is not generally aligned, due to the location and/or orientation of the anchoring units, the clinician can remove the prosthesis and modify the anchoring units accordingly as illustrated in step 308. For example, if the anchoring unit is positioned too high with respect to the jaw, the clinician can reduce the overall height of the anchoring unit by removing portions of the anchoring unit (e.g., by reducing the height of the coping 130), such as the proximal end. If the inverse is true and the anchoring unit is positioned too low with respect to the jaw, the clinician can also increase the overall height of the anchoring unit by adding portions to the anchoring unit or by modifying other portions of the anchoring unit. If the anchoring unit is positioned at an incorrect angle, the clinician can modify the angling of the anchoring unit. It should be understood that any modifications can be made to the anchoring unit in order to achieve a satisfactory fit between the prosthesis and the anchoring unit. Furthermore, it should also be understood that, as an alternative procedure, the clinician can also modify the size, position and/or angle of the blind holes in the prosthesis to achieve a generally aligned fit. Upon making appropriate modifications to the anchoring units and/or prosthesis, the clinician can proceed back to step 306 to test the fit of the prosthesis with the modified anchoring units. The clinician can repeat steps 306 and 308 until a generally aligned fit is achieved.

As shown in step 310, after the clinician has determined that a satisfactory preliminary fit has been achieved, the clinician can attach the prosthesis to the coping using any of the connection features as herein discussed. Preferably, the clinician attaches the prosthesis to the coping such that the prosthesis and coping are aligned and oriented properly with respect to the opposing dentition.

For example, in some procedures, the clinician can apply a bonding agent, such as self-curing, light-curing, or other polymeric material, to the prosthesis. In some procedures, the clinician can backfill holes formed in the prosthesis with an acrylic, such as a self-curing acrylic or a light cured composite. In some procedures, the clinician can remove the prosthesis from the anchoring units and introduce the bonding agent to the blind holes and/or backfill the blind holes with an acrylic and reseat the prosthesis on the copings after the bonding agent and/or acrylic has been applied. During the bonding process, the patient's teeth can be placed in a centric occlusion to mate the occlusal surfaces of the prosthesis to the opposing dentition. Since the bonding agent and/or acrylic can have a low viscosity prior to curing and because the copings can have some degree of play within the blind holes, the orientation of the prosthesis with respect to the coping can be further modified or altered during this step. The prosthesis and coping can then be fully cured, either via passage of time or introduction of a catalyst, such as light, to the bonding agent and/or acrylic such that the prosthesis and coping are attached in the modified or altered orientation.

Accordingly, upon curing of the bonding agent and/or acrylic, the prosthesis and coping can be placed such that the provisional prosthesis is in a more proper relationship with the opposing dentition as compared with the preliminary fit. This can significantly enhance comfort and fit of the provisional prosthesis. Moreover, this considerably reduces the amount of guesswork being performed by the clinician who would normally be tasked with estimating the proper orientation and alignment of the prosthesis. In edentulous cases, this can be particularly advantageous as it further allows the clinician to establish the proper jaw relationship with the opposing dentition. It should be understood that other relationships between the prosthesis and opposing dentition can be chosen. For example, the patient can instead close into maximum intercuspation so that the provisional prosthesis is properly aligned in this orientation.

In some procedures, other connection features can be used to attach the prosthesis to the coping. For example, the provisional prosthesis can be attached to the coping via a fastener, a “snap-fit,” a friction fit, a collar, or other connection features.

As shown in step 312, the clinician can remove the prosthesis from the patient's jaw after the bonding agent and/or acrylic has sufficiently cured such that the prosthesis is attached to at least the coping. Since the coping is attached to the prosthesis via the cured bonding agent and/or acrylic and because the coping can be attached to the anchoring unit using a “snap-fit,” a friction fit, or other similar provisional connection feature, removal of the prosthesis can result in the copings being detached from the anchoring unit. During this process, the anchoring units can remain attached to the prosthesis in an aligned configuration. Accordingly, it should be appreciated that the threshold separation force to overcome the “snap-fit,” friction fit, or other provisional connection feature can be chosen such that little to no misalignment between the prosthesis and coping is caused when removing the prosthesis and coping from the anchoring unit.

As shown in step 314, the clinician can then use a cutting tool to create a through hole into the prosthesis and coping. In some procedures, the clinician can align the through hole such that the through hole provides access to a connection feature on the abutment. As shown in step 316, in order to more securely fasten the prosthesis to the anchoring unit, a clinician can use a fastener (e.g., prosthetic screw) to fasten the prosthesis and coping to the anchoring unit. During this step, the clinician can insert a separate fastener, such as a screw or bolt, into the recently created through-hole. The separate fastener can positively engage a connection feature of the anchoring unit, such as internal threading on the abutment, such that the prosthesis is attached to the anchoring unit via the separate fastener. Accordingly, the entire provisional prosthetic system can be attached using threads thereby further reducing the likelihood that the components of the system will become inadvertently detached from each other.

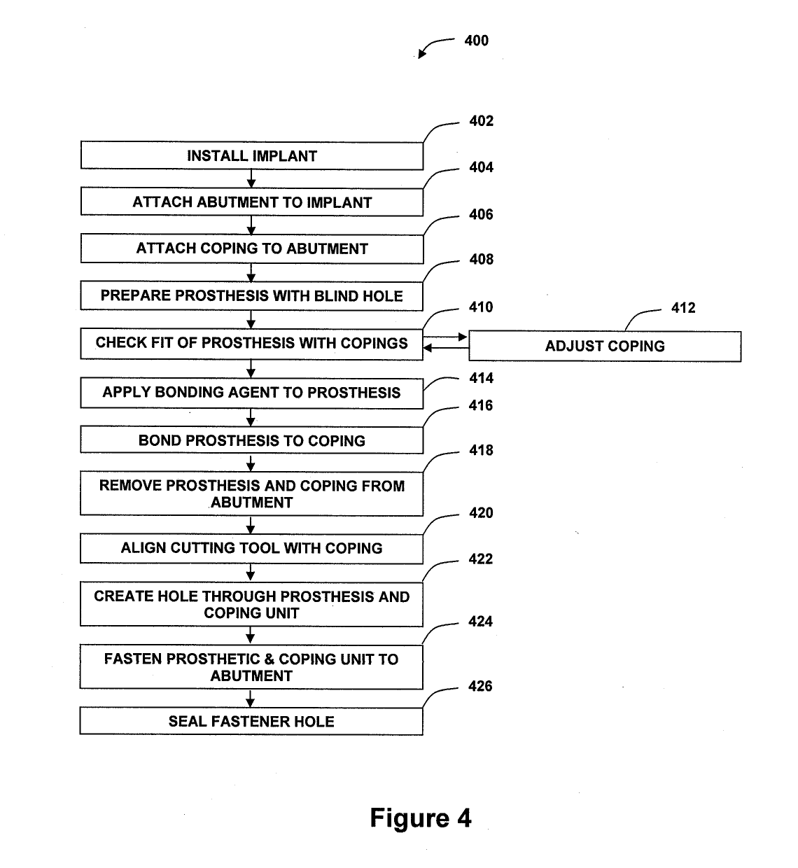

FIG. 4 illustrates a flowchart describing steps of a method 400 for attaching a provisional dental prosthetic system such as the provisional dental prosthetic system 100. Certain of the steps of method 400 are similar to those of method 300. For purposes of clarity, the steps are described as being performed by a clinician; however, it should be understood that some or all of the steps of this procedure can be performed by others such as, but not limited to, the clinician's assistants and other third-parties. Moreover, the some or all of the steps described herein can be performed either in situ (i.e., in the patient's mouth) or ex situ. For example, some or all of the steps described herein can be performed on a molding of the patient's teeth.

As shown in step 402, a clinician can affix attachment mechanisms to the patient's jaw for allowing installation of additional dental components. Accordingly, during this step, the clinician can affix one or more implants to the patient's jaw. As with method 300, the remainder of the method 400 can either be performed immediately after this step or shortly thereafter.

As shown in step 404, the clinician can attach an abutment to the implant using any of the connection features and techniques as herein described. For example, in some embodiments, the abutment can be attached to the implant using a threaded coupling screw. However, it should be understood that other connection features and techniques can also be used for attaching the abutment to the implant. For example, in some embodiments, the abutment can be attached to the implant using a “snap fit” connection, friction fit connection, and/or other such connection features.

As shown in step 406, the clinician can attach a coping to the abutment using any of the connection features and techniques as herein described. For example, in some embodiments, the coping can be attached to the abutment using a “snap-fit” connection feature on the abutment and the coping. Accordingly, the clinician can simply exert a sufficient force upon the coping in a direction towards the abutment until the “snap-fit” connection feature has been properly engaged. In some embodiments, the “snap-fit” connection feature can provide some form of feedback to the clinician to indicate that the “snap-fit” connection feature has been properly engaged. For example, the “snap-fit” connection feature can provide audible feedback, tactile feedback, or a combination of both to the clinician to alert the clinician of proper engagement of the coping with the abutment.

As shown in step 408, the clinician can then prepare the prosthesis for attachment to the coping. As described above with respect to method 300, the prosthesis can be prepared chairside using either the patient's existing prosthesis or a newly fabricated prosthesis. The prosthesis can be provided with blind holes or the clinician can create such blind holes during the procedure. These blind holes can be aligned such that the prosthesis would be properly oriented within the patient's mouth upon completion of the method 400. Furthermore, the blind holes can be designed to allow some degree of play between the blind holes and the coping.

As shown in step 410, the clinician can test the prosthesis for preliminary fit by seating the prosthesis on the copings. During this step, the clinician can place the prosthesis over the copings such that the copings are received within one or more blind holes of the prosthesis. Upon placement of the prosthesis over the copings, the clinician can check to see whether the prosthesis is generally aligned with respect to the patient's jaw and opposing dentition. For example, the clinician can determine whether the occlusal surfaces are generally aligned and whether the patient's nose, lips and chin are generally aligned.

The clinician can also determine whether the vertical dimension of occlusion (VDO) and/or vertical dimension at rest (VDR) is properly chosen. The VDO indicates the superior-inferior relationship between the maxilla and mandible when the teeth are in maximum intercuspation. Accordingly, particularly for patients who are fully and/or partially edentulous and thus lack the teeth to position in maximum intercuspation, the clinician can perform one or more tests determine a proper VDO and/or VDR. For example, the clinician can view the overall appearance of the patient when the prosthesis is seated on the coping to determine whether the patient's nose, lips and chin appear to be in an ordinary configuration of the average person. The clinician can also determine a proper VDO and/or VDR by listening to the patient's pronunciation of certain words. The clinician can take any number of steps to ensure that a proper VDO and/or VDR will be established upon the prosthesis being seated on the copings. For example, to increase the distance between the prosthesis and the coping, the clinician can add pads to either the coping and/or the prosthesis. To decrease the distance between the prosthesis and the coping, the clinician can trim down the top most portion of the coping and/or drill a longer blind hole through the prosthesis.

The clinician can check to see whether only minor adjustments would be needed to place the prosthesis in proper alignment and achieve a proper VDO and/or VDR. Preferably, the adjustments should be sufficiently aligned such that any remaining adjustments made during the bonding step 416 can take place by placing the patient's teeth in a centric occlusion to mate the occlusal surfaces of the prosthesis to the opposing dentition.

Should the clinician determine that the prosthesis is not properly aligned, due to the location and/or orientation of the copings, the clinician can remove the prosthesis and modify the copings accordingly as illustrated in step 412. Steps to modify the copings are described in connection with step 308 above. Furthermore, it should also be understood that, as an alternative procedure, the clinician can also modify the size, position and/or angle of the blind holes in the prosthesis to achieve a generally aligned fit. Upon making appropriate modifications to the coping and/or prosthesis, the clinician can proceed back to step 410 to test the fit of the prosthesis with the modified copings. The clinician can repeat steps 410 and 412 until a generally aligned fit is achieved.

As shown in step 414, after the clinician has determined that a satisfactory fit has been achieved, the clinician can apply a bonding agent, such as self-curing or light-curing polymeric material, to the prosthesis. In some procedures, the clinician can backfill holes formed in the prosthesis with an acrylic, such as a self-curing acrylic or a light cured composite. In some procedures, the clinician can remove the prosthesis from the copings and introduce the bonding agent and/or acrylic to the blind holes. The amount of bonding agent and/or acrylic chosen should be sufficient to adequately cover the copings upon placement of the prosthesis on the copings as this can enhance the connection between the coping and the prosthesis. However, care should be taken such that the blind holes are not overfilled thus causing the bonding agent and/or acrylic to leak onto other components or onto soft tissue thereby potentially causing complications and increasing the overall procedural time. Of course, a greater or lesser amount of bonding material and/or acrylic can be used based on the bonding strength desired.

As shown in 416, after the clinician has applied the bonding agent to the prosthesis and/or backfilled the blind holes with an acrylic, the clinician can then bond the prosthesis to the copings. In procedures where the bonding agent and/or acrylic was applied to the blind holes, this can be achieved by simply seating the prosthesis in the same manner as was performed during step 410. During the bonding process, the patient's teeth can be placed into a centric occlusion to mate the occlusal surfaces of the prosthesis to the opposing dentition. Accordingly, the prosthesis can advantageously be placed in a more proper relationship with the opposing dentition. It should be understood that other relationships between the prosthesis and opposing dentition can be chosen. For example, the patient can instead close into maximum intercuspation so that the prosthesis is properly aligned in this orientation.

As shown in step 418, after the bonding agent and/or acrylic has sufficiently cured such that the prosthesis is attached to the coping, the clinician can remove the prosthesis from the abutments. Since the copings are attached to the prosthesis via the cured bonding agent and/or acrylic and because the copings are attached to the abutments using only a “snap-fit,” friction fit, or other similar provisional connection, removal of the prostheses can result in the copings being removed along with the prosthesis. Moreover, since the copings remain attached via the cured bonding agent and/or acrylic, the copings can remain attached to the prosthesis in an aligned configuration. Accordingly, it should be appreciated that the threshold separation force to overcome the “snap-fit,” friction fit, or other provisional connection feature can be chosen such that little to no misalignment between the prosthesis and coping is caused when removing the prosthesis and coping from the abutment.

As shown in steps 420 and 422, a through-hole can be created in the prosthesis and the coping to allow for a fastener, such as a screw or bolt, to pass through the prosthesis and coping. During these steps, the clinician can use a cutting tool such as cutting tool 160 to prepare the through-hole.

As shown in step 420, in order to assist with proper placement and alignment of the through-hole, the clinician can first attach an alignment tool, similar to alignment tool 170, to the coping. In some procedures, the alignment tool can be attached to the coping using a “snap-fit,” friction fit, or other provisional connection feature. In some procedures, the alignment tool can be keyed to ensure that the alignment tool is properly oriented with respect to the coping. Upon attaching the alignment tool to the coping, the clinician can then insert the cutting tool through an alignment feature, such as alignment bore 172, and create a through hole into the coping and prosthesis as is shown in step 422. In some embodiments, an alignment tool 170 might not be used. In some embodiments, step 422 can include an additional step of creating an additional hole through the prosthesis from the occlusal surface towards the coping. This additional hole can have a greater diameter than the original through-hole and be generally coaxial with the original through-hole. This step can be performed when a fastener being used is larger than the original through-hole.

As shown in step 424, in order to more securely fasten the prosthesis to the abutments, a clinician can use a fastener to fasten the prosthesis to the abutment. During this step, the clinician can insert a separate fastener, such as a screw or bolt, into the recently created through-hole. The separate fastener can positively engage a connection feature on the abutment, such as internal threading, such that the prosthesis and coping is attached to the abutment via the separate fastener. Accordingly, the entire provisional prosthetic system can be attached using threads thereby reducing the likelihood that the components of the system will become inadvertently detached.

As shown step 426, the clinician can then seal the through-hole with a sealing agent to enhance the appearance of the prosthesis and prevent or at least reduce the likelihood of foreign matter collecting within the through hole. Upon removal of the prosthesis, such as may be the case prior to attachment of a permanent prosthetic system, the clinician can remove the sealing agent to regain access to the separate fastener and remove the prosthesis and coping from the abutment.

### Provisional Dental Prosthesis and Attachment System

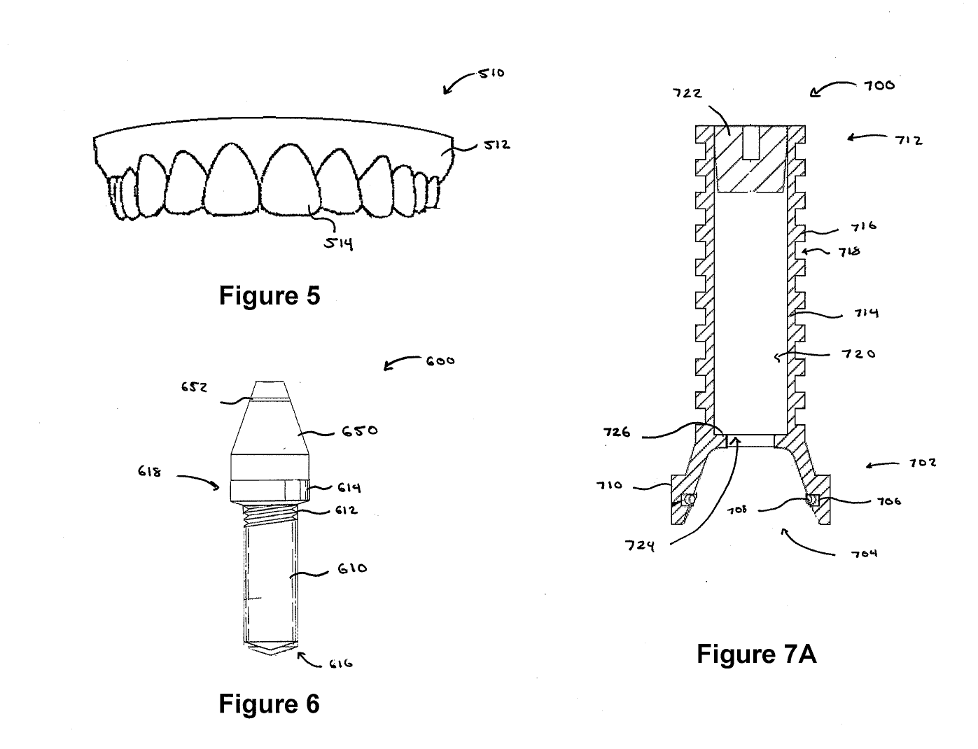

With reference to FIG. 5, an embodiment provisional prosthesis 510 is illustrated which can be used in a provisional dental prosthesis system described herein. The provisional prosthesis 510 can include a base 512 upon which one or more prosthetic teeth 514 are attached. The base 512 can include a first side on which the teeth 514 are attached and a second side opposite the first side configured to be placed in contact with soft tissue adjacent the patient's jawbone. As shown in the illustrated embodiment, the provisional prosthesis 510 can be a full bridge such that the provisional prosthesis 510 replaces the entire set of teeth along either the maxillary and/or mandibular arches. As noted above, the provisional prosthesis 510 can also be a partial bridge that replaces fewer than the entire set of teeth along the maxillary and/or mandibular arches. Furthermore, as noted above, the provisional prosthesis 510 can also be a crown to replace a single tooth. In some embodiments, the provisional prosthesis 510 can be a patient's existing prosthesis such as a full or partial denture.

FIG. 6 illustrate components of an anchoring unit 600 which can include a dental implant 610 and an abutment 650. In the illustrated embodiment, the implant 610 can include threading 612 about an external surface of the implant 610 and a flange 614. The threading 612 can be used to fasten the implant 610 to bone in the patient's jaw and the flange 614 can be designed to sit atop the bone such that the implant 610 remains above soft tissue surrounding the bone. As shown in the illustrated embodiment, the threading 612 can extend partially from the flange 614 towards a distal end 616 of the implant 610. Such threading 612 can extend further towards the flange 614 to increase the threaded contact surface of the implant 610. Furthermore, the threading 612 can begin at a position below the flange 614. At a proximal end 618 of the implant 610, an abutment 650 can be attached using any of the connection features and techniques as herein described. For example, the implant 610 can include an internally threaded bore (not shown) configured to engage a threaded shaft of the abutment 650. It should be appreciated that, in some embodiments, the flange 614 can be omitted and the threading 612 can extend towards the proximal edge of the implant.

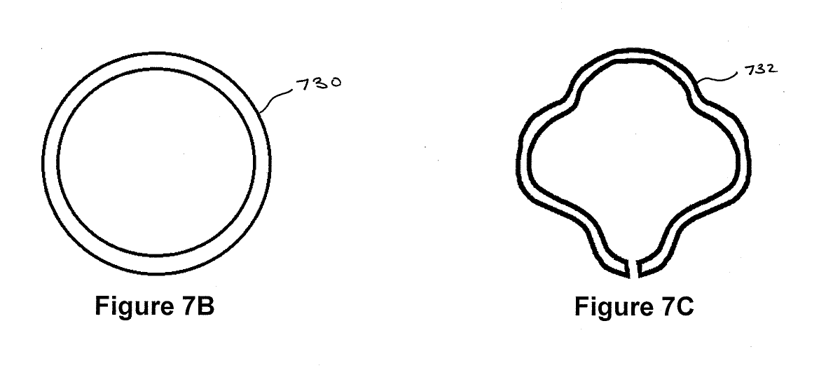

The abutment 650 can include an annular slot 652 circumscribing a proximal portion 654 of the abutment 650. This annular slot 652 can serve as a provisional connection feature between the abutment 650 and the coping 700. Other shapes and designs can also be used. For example, in some embodiments, the slot 652 can circumscribe only portions of the abutment 650. Moreover, the abutment 650 can include annular protrusions or ribs, dimples circumscribing the abutment 650, or a combination of any of the above. In some embodiments, the abutment 650 can include vertically oriented slots or protrusions which can both facilitate alignment of the abutment 650 with another component, such as a coping 700 (shown in FIG. 7A). The abutment 650 can include pins or dowels, or holes configured to receive pins or dowels on an attached component, as connection features. In some embodiments, the abutment 650 can omit slot 652.

As shown in the illustrated embodiment, the proximal portion of the abutment 650 can have a frustoconical shape which tapers towards the proximal end. However, it should be understood that the proximal portion of the abutment 650 can have any other type of shape and need not exhibit rotational symmetry. As described above, the proximal portion and/or the distal portion (not shown) of the abutment 650 can be keyed such that components attached thereto can be in only certain orientations.

With reference now to FIG. 7A, the coping 700 can include a distal portion 702 having a cavity 704 sized and shaped to receive at least some portion of the proximal portion of the abutment 650. The cavity 704 can have a frustoconical shape, or any other shape, similar to that of the abutment 650. Preferably, the cavity 704 is shaped to closely fit the shape of the abutment 650. In some embodiments, the cavity 704 can be sized and shaped to receive a keyed feature on the abutment 650 to further ensure that the abutment 650 and the coping 700 are properly aligned and oriented prior to attachment. The cavity can also include an annular recess 706 located along an interior surface of the cavity 704. The recess 706 can be sized and to receive a resilient spring element 708 thereby forming a provisional connection feature designed to positively engage the annular slot 652 of the abutment 650. The resilient spring element 708 can be designed to provide the clinician with audible and/or tactile feedback when the spring element 708 engages the slot 652. It should be appreciated that use of a separate resilient spring element 708 can advantageously allow the coping 700 to be manufactured from a less resilient, and potentially more durable, material that can be more resistant to deformation. This increased durability can reduce the likelihood that the coping 700 deforms upon removal of the coping 700 from the abutment 650 as described in connection with FIG. 4. In some embodiments, the spring element 708 can be an annular ring spring 730 (FIG. 7B) which projects radially inward and beyond the recess 706 such that it can positively engage annular slot 652 of the abutment 650. In some embodiments, the annular ring spring 730 can include resiliently deformable fingers (not shown) which project radially inward and beyond the recess 706. In some embodiments, a wave spring 732 (FIG. 7C) which has portions which project radially inward beyond the recess 706 can be used. The wave spring 732 can be a flat wire wave spring, a single turn wave spring, a Marcel Expander or other type of wave spring as desired. The spring element 708 can have flat or non-flat cross-section including a circular cross-section. Other types of designs can be used such as Belleville washers, curved disc springs, wave washers, split washers, internal and/or external tooth lock washers, internal and/or internal serrated washers. The characteristics of the spring element 708 can be chosen such that the spring element 708 can maintain the positioning and orientation of the abutment 650 and the coping 700 during the procedure described above yet still be removable without significant force. In the illustrated embodiment, the wave spring 732 includes four (4) radially inward projections. In modified embodiments, the wave spring can include more or less projections, such as, for example, 1, 2, 3, 5, or 6 projections. One advantage of the illustrated wave spring arrangement is that the arrangement can still provide an inward force even if a portion of the radially inward projections encounters an opening in the annular slot 652 (see e.g., FIG. 14 and slot 910).

In some embodiments, other structures can be used to create a provisional connection feature. For example, the coping 700 can include an annular rib, protrusion, dimples or similar resilient features to interact with the annular slot 652. Furthermore, the vertically oriented slots or protrusions can also be included along the interior surface of the cavity 704. Along the outer surface of the distal portion 702, the coping 700 can include a flange 710.

The proximal portion 712 of the coping 700 can include an elongate member 714 extending in a longitudinal direction. The elongate member 714 can include multiple annular projections 716 or ribs which project outwardly from the elongate member 714 in a radial direction. The annular projections 716 can be spaced apart to form annular slots 718. As will be described in further detail below, inclusion of the projections 716 and slots 718 along the elongate member 714 can advantageously enhance the connection between the coping 700 and the prosthesis 510 when a bonding agent and/or acrylic is used. In some embodiments, protrusions 716 can extend only partially around the elongate member 714 and can extend only partially along the length of the elongate member 716. Other structures can be also used for providing a similar benefit. For example, dimples or bosses can also be used with or without the protrusions 716 and slots 718. Furthermore, the surfaces of the coping 700 can be roughened. In some embodiments, these protrusions 716, slots 718, dimples, and/or bosses can also be included on interior surfaces of the elongate member 714 and therefore be located within a bore 720. Similar structures, e.g., grooves, can also be used on the exterior surface of the flange 710 of the coping.

As shown in the illustrated embodiment, the elongate member 714 can include a longitudinal bore 720 through at least a portion of the elongate member 714. As will be described in further detail below, this bore 720 can be sized and shaped to allow a fastener to pass therethrough. At a proximal end of the bore 720, a plug 722 can be provided which can reduce the likelihood of foreign materials entering into the bore 720. The plug 722 can be manufactured from the same material as the coping 700 or be manufactured from a different material. In some embodiments, it can be preferable to manufacture the plug 722 from a softer material to facilitate cutting or drilling the plug 722. At an opposite end of the bore 720, the coping 700 can include an aperture 724 and a rim 726.

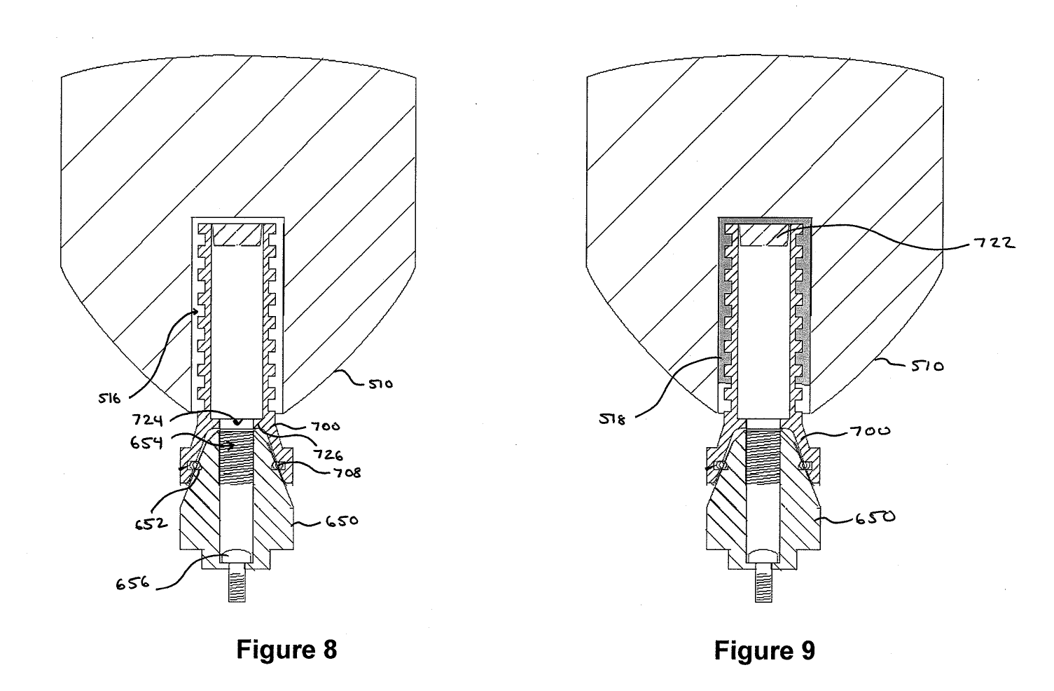

With reference now to FIG. 8, an abutment 650 is shown inserted into the cavity 704 of the coping 700 and the elongate member 714 of the coping 700 is shown inserted into a bore 516 of the prosthesis 510 with prosthesis 510 seated on the elongate member 714. As shown in the illustrated embodiment, coping 700 has been partially modified to reduce the overall height of the elongate member 714. As described above in connection with FIGS. 3 and 4, this can be performed by the clinician to achieve a more satisfactory fit between the prosthesis 510 and the coping 700. Furthermore, as shown in the illustrated embodiment, the abutment 650 and the coping 700 can be attached via the retention spring 708. In some embodiments, the aperture 724 can be aligned with a bore 654 of the abutment 650 with the rim 726 adjacent to and contacting at least a portion of the proximal end of the abutment 650. As shown in the illustrated embodiment, the bore 654 can be partially or entirely internally threaded or include a connection feature. Moreover, a coupling screw 656 can pass through the bore 654 for coupling the abutment to the implant 600.

With reference now to FIG. 9, a bonding agent 518 such as a self-curing or light curing polymeric material, and/or an acrylic, can be introduced into the bore 516 of the prosthesis 510. Upon curing of the bonding agent 518 and/or acrylic, the prosthesis 510 and the coping 700 can be securely attached. This attachment can be enhanced via use of surface features such as protrusions 716 and slots 718. Furthermore, this attachment can be further enhanced by increasing the surface roughness of the interior surfaces of bore 516. It should be appreciated that due to the existence of plug 722, the bonding agent 518 and/or acrylic is not introduced into the bore 720. During a cutting or drilling operation, this can advantageously reduce the likelihood of difficulties associated with cutting or drilling through the cured bonding agent 518 and/or acrylic which could potentially gum up the cutting surfaces of the cutting tool. In some embodiments, the plug can be removed to allow the bonding agent 518 and/or acrylic to be received within the bore 720. Such an embodiment may be advantageous when a more secure bond between the prosthesis 510 and the coping 700 is desired.

The metal surfaces of components can be surface treated to further enhance bonding. In some embodiments, a primer can be applied to surfaces of components of the provisional dental prosthesis system such as the coping 700. For example, a metal primer can be applied to metal surfaces of components to enhance the bond between the metal surfaces and the bonding agent 518 and/or acrylic. In some embodiments, the primer can advantageously enhance the bond between the metal surface of the component and bonding agent 518 and/or acrylic. The primer can be pre-applied to such surfaces such that the clinician need not apply the primer during the procedure. In some embodiments, the surfaces of components can include other surface treatments for further enhance the bond between the surface and the bonding agent 518 and/or acrylic. For example, the surfaces of components, such as metal components, can be roughed to further enhance the bond between the component and the bonding agent 518 and/or acrylic. This can be achieved by sandblasting or other means of roughening a surface.

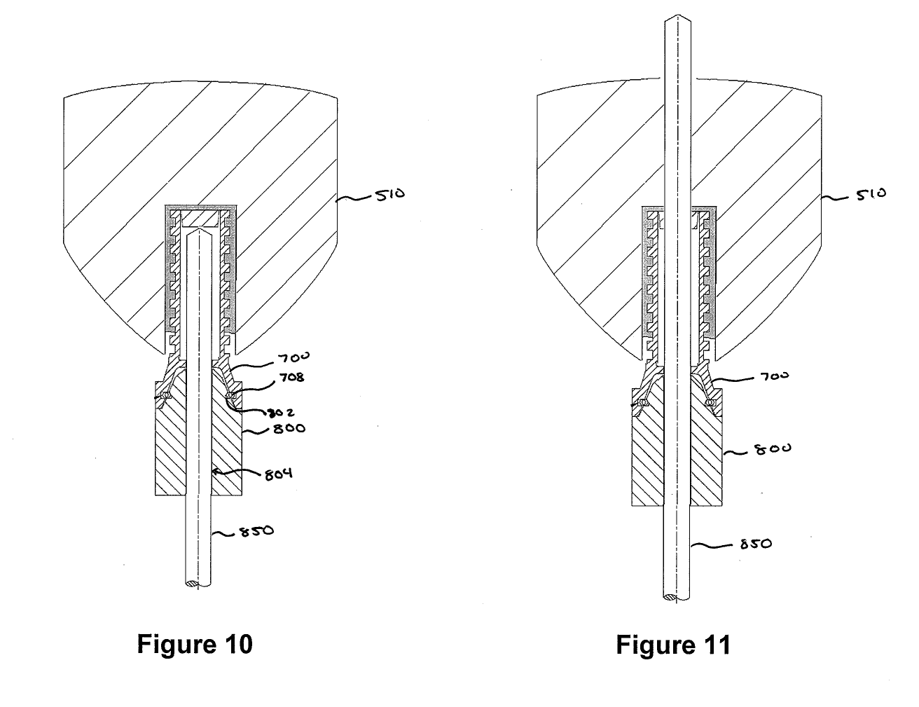

With reference now to FIGS. 10 and 11, an alignment tool 800 is shown inserted into the cavity 704 of the coping 700 and the elongate member 714 of the coping 700 is shown inserted into a bore 516 of the prosthesis 510 with prosthesis 510 seated on the elongate member 714. Furthermore, a drill bit 850 is shown inserted into the alignment tool 800 and the bore 720 of the coping 700. As shown in the illustrated embodiment, the alignment tool 800 can have a shape similar to that of the abutment 650 and include a similar connection feature in the form of an annular slot 802 for receiving the retention spring 708. Other connections features between the alignment tool 800 and coping 700 are also contemplated. For example, the alignment tool 800 can be attached to the coping 700 using other “snap fit” connections as herein described, friction fit connections, clamps, fasteners, and the like. For example, the alignment tool 800 can be inserted into the cavity of the coping 700 with a friction fit connection or the distal portion of the coping 700 can be inserted into a cavity of the alignment tool 800 (e.g., a drill guide) with a friction fit connection. The alignment tool 800 can include an alignment bore 804 to receive and align the drill bit 850 as the drill bit 850 passes through the alignment tool 800. As shown in the illustrated embodiment, the alignment bore 804 can be aligned with the aperture 724 of the coping 700 such that the drill bit 850 passes through aperture 724. The drill bit 850 can then be used to create a bore 519 through the plug 722, portions of the bonding agent 518 and/or acrylic, and the prosthesis 510 as shown in FIG. 9. As described herein, in some embodiments, an alignment tool 800 might not be used. As also described herein, in some embodiments, after the bore through the prosthesis 510 is created from the coping 700 or provisional crown side, the drill bit 850 or another drill bit can reinforce and/or enlargen the bore by entering from the prosthesis 510 side.

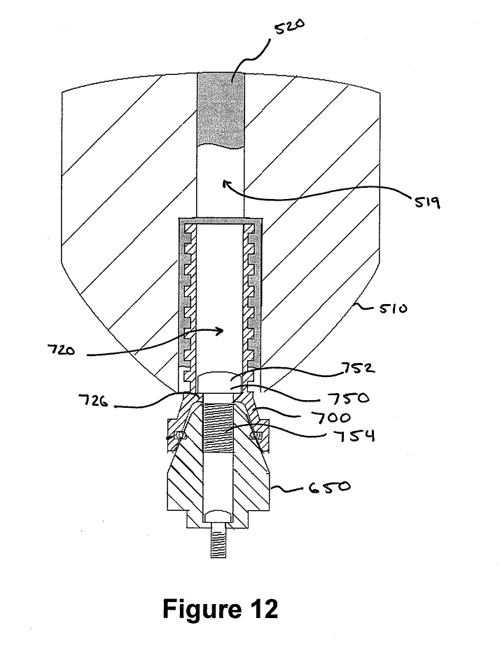

With reference now to FIG. 12, an abutment 650 is shown inserted into the cavity 704 of the coping 700 and the elongate member 714 of the coping 700 is shown inserted into a bore 516 of the prosthesis 510 with prosthesis 510 seated on the elongate member 714. Furthermore, a fastener 750 has been inserted into the bore 519 and into bore 720 such that the head 752 of the fastener 750 is adjacent to and seated on the rim 726 and the shaft 754 is inserted through aperture 724 and into bore 654 of the abutment 650. In some embodiments, the shaft 754 can be threaded along an exterior surface such that it engages corresponding threading within bore 654. Accordingly, the coping 700 and prosthesis 510 can be securely attached to the abutment 650 using the threaded screw. In order to reduce the likelihood of foreign material entering into bore 519, a seal 520 can be introduced into the bore 519.

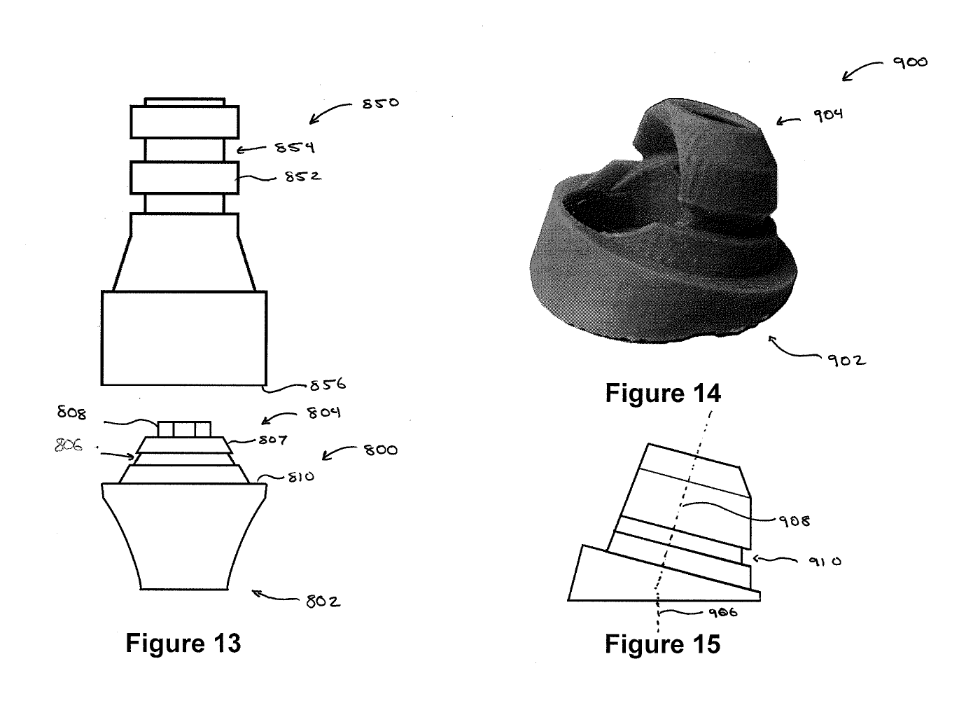

With reference now to FIG. 13, another embodiment of an upper portion of an abutment 800 (e.g., a multi-unit abutment) and coping 850 is illustrated. The abutment 800 can have a distal portion 802 for attachment to an implant and a proximal portion 804 for attachment to a coping such as coping 850 and/or to a dental component such as, for example, a dental restoration or dental restoration component, such as, for example, a multi-unit bridge and/or restoration. As shown in the illustrated embodiment, the abutment 800 can include a recess slot 806, such as an annular slot, about a proximal portion 804 of the abutment 800. Similar to annular slot 652, slot 806 can serve as a provisional connection feature between the abutment 800 and the coping 850 and/or the coping configurations described above. Other shapes and designs can also be used. For example, in some embodiments, the slot 806 can circumscribe only portions of the abutment 800. Moreover, the abutment 800 can include annular protrusions or ribs, dimples circumscribing the abutment 800, or a combination of any of the above. In some embodiments, the abutment 800 can include vertically oriented slots or protrusions which can both facilitate alignment of the abutment 800 with another component, such as a coping 850. The abutment 800 can include pins or dowels, or holes configured to receive pins or dowels on an attached component, as connection features. In some embodiments, the abutment 800 can omit slot 806.

The proximal portion 804 can have a frustoconical shape which tapers towards the proximal end. A tapered portion 807 can be designed to facilitate the placement of the coping over the abutment 800 by providing a lead-in ramp for the provisional connection features of coping 850, such as spring element 708, designed to positively engage the slot 806 of the abutment 800. Of course, it should be understood that the proximal portion of the abutment 800 can have any other type of shape as desired. Moreover, as shown in the illustrated embodiment, the abutment 800 can include a keyed feature 808 such that the component attached thereto, such as the coping 850 is properly aligned prior to coupling with the abutment 800. This keyed feature 808 can have, for example, a hexagonal cross section designed to engage a corresponding hexagonal recess in the coping. Other shapes can be used for keyed feature 808 such as other types of polygons, lobular shapes such as trilobular and hexalobular shapes, elliptical shapes, and any other shape as desired.

In some embodiments, the proximal portion 804 can include a flange forming a seat 810. The seat 810 can be designed to contact a portion of the coping 850, such as the distal end surface 856, upon the coping 850 being coupled via the provisional connection feature, a prosthetic screw, or both. The seat 810 can advantageously serve as a stop element for the coping which can prevent or reduce the likelihood that a clinician overshoots insertion of the coping over the abutment 800. The seat 810 can also be used to support a final or temporary restoration such as, for example, multiple unit abutment, bridge, and/or restoration.

With continued reference to FIG. 13, the coping 850 can have a similar design to that of coping 700. For purposes of brevity, reference should be made to the discussion of coping 700 for details regarding the internal structure of coping 850. As shown in FIG. 13, the coping 850 can include fewer protrusions 852 and slots 854 As described above, the surfaces of components can be surface treated to further enhance bonding. In some embodiments, a primer can be applied to surfaces of components of the provisional dental prosthesis system such as the coping 850. For example, a metal primer can be applied to metal surfaces of components to enhance the bond between the metal surfaces and the bonding agent 518 and/or acrylic. In some embodiments, the primer can advantageously enhance the bond between the metal surface of the component and an acrylic bonding agent 518 and/or acrylic. The primer can be pre-applied to such surfaces such that the clinician need not apply the primer during the procedure. In some embodiments, the surfaces of components can include other surface treatments for further enhance the bond between the surface and the bonding agent 518 and/or acrylic. For example, the surfaces of components, such as metal components, can be roughed to further enhance the bond between the component and the bonding agent 518 and/or acrylic. This can be achieved by sandblasting or other means of roughening a surface.

With reference now to FIGS. 14 and 15, another embodiment of an upper portion of an abutment 900 is illustrated. Abutment 900 can include a distal portion 902 for attachment to an implant and a proximal portion 904 for attachment to a coping such as coping 850 and/or to a dental component such as, for example, a dental restoration or dental restoration component such as, for example, a multi-unit bridge and/or restoration. As shown in the illustrated embodiment, abutment 900 is angled such that the longitudinal axis 906 of the distal portion 902 forms an angle with the longitudinal axis 908 of the proximal portion 904. Accordingly, when the abutment 900 is attached to an implant and a coping, the coping would form an angle with the implant. Such an angle can be desirable, for example, if the implant is affixed to the jaw such that the implant is not generally orthogonal to the occlusal plane. In some embodiments, a first screw, similar to coupling screw 16, can be used to couple the abutment 900 to an implant. In some embodiments, the first screw can be oriented parallel to axis 906. Of course, the first screw can also be oriented along another axis. A second screw, similar to prosthetic screw 138, can be used to couple the coping, such as coping 850, to the abutment 900. In some embodiments, the second screw can be oriented parallel to axis 908. As with first screw, the second screw can be oriented along another axis. In some embodiments, the first screw and the second screw can be oriented parallel to different axes. Accordingly, it should be understood that the abutment 900 can include one or more bores to receive such screws.

As shown in the illustrated embodiment, the abutment 900 can include slot 910, such as an annular slot, about a proximal portion 904 of the abutment 900. Similar to annular slot 652, slot 910 can serve as a provisional connection feature between the abutment 900 and the coping 850. Other shapes, designs and features described in connection with abutment 800 can also be used with abutment 900. For purposes of brevity, reference should be made to the discussion of abutment 800 for details regarding such features. In some embodiments, the abutment 900 can omit slot 910.

As shown in the illustrated embodiment, the proximal portion of the abutment 900 can have a frustoconical shape which tapers towards the proximal end. However, it should be understood that the proximal portion of the abutment 900 can have any other type of shape and need not exhibit rotational symmetry. Moreover, the abutment 900 can include a keyed feature (not shown) such that the component attached thereto, such as the coping 850 is properly aligned prior to coupling with the abutment 900.

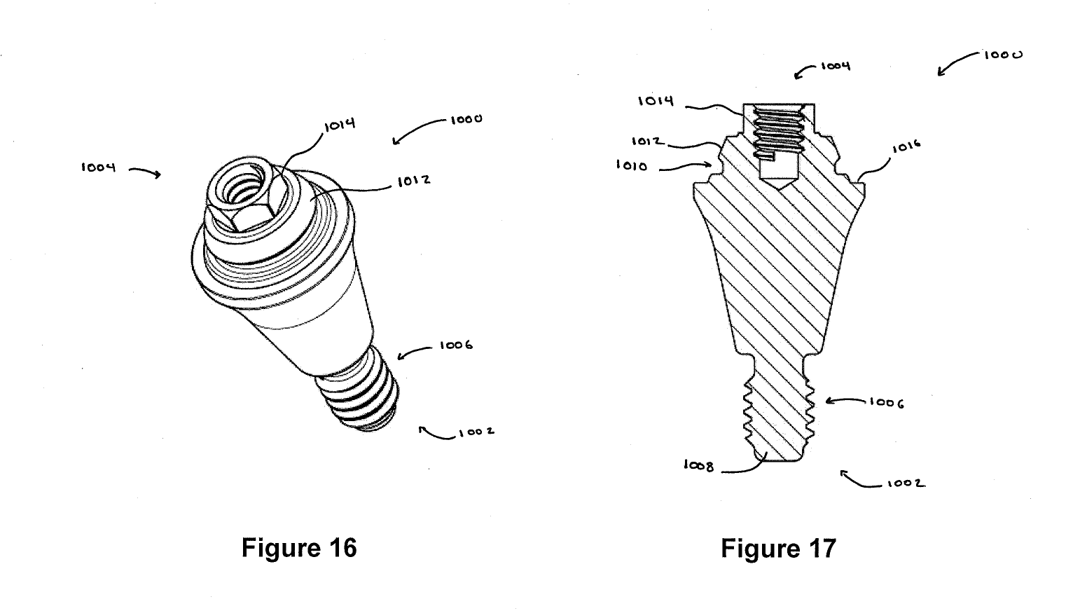

With reference now to FIGS. 16 and 17, an embodiment of an abutment 1000 is illustrated. Abutment 1000 can have features similar to those of abutments 650, 800, 900. As shown in the illustrated embodiment, the abutment 1000 can include a distal portion 1002 for attachment to an implant and a proximal portion 1004 for attachment to a coping such as those described herein. Along the distal portion 1002, the abutment 1000 can include a threaded portion 1006, the threaded portion having a shaft 1008 with external threading at least partially, if not entirely, along its length. The threading of the threaded portion 1006 can be designed to couple with a corresponding internally threaded portion of an implant. As shown in the illustrated embodiment, the threaded portion 1006 can be integrally formed with the abutment 1000. Accordingly, a clinician can attach the abutment 1000 to an implant by rotating the entire abutment 1000. The monolithic structure can provide greater structural integrity compared to a two-piece structure. In some embodiments, the abutment 1000 can instead utilize a coupling screw, similar to coupling screw 16, that passes through an internal bore (not shown) of the abutment 1000 similar to the internal bore 125. The clinician can then attach the abutment 1000 to an implant without rotating the entire abutment 1000. This can be particularly advantageous in situations where it would be difficult to rotate the abutment 1000.

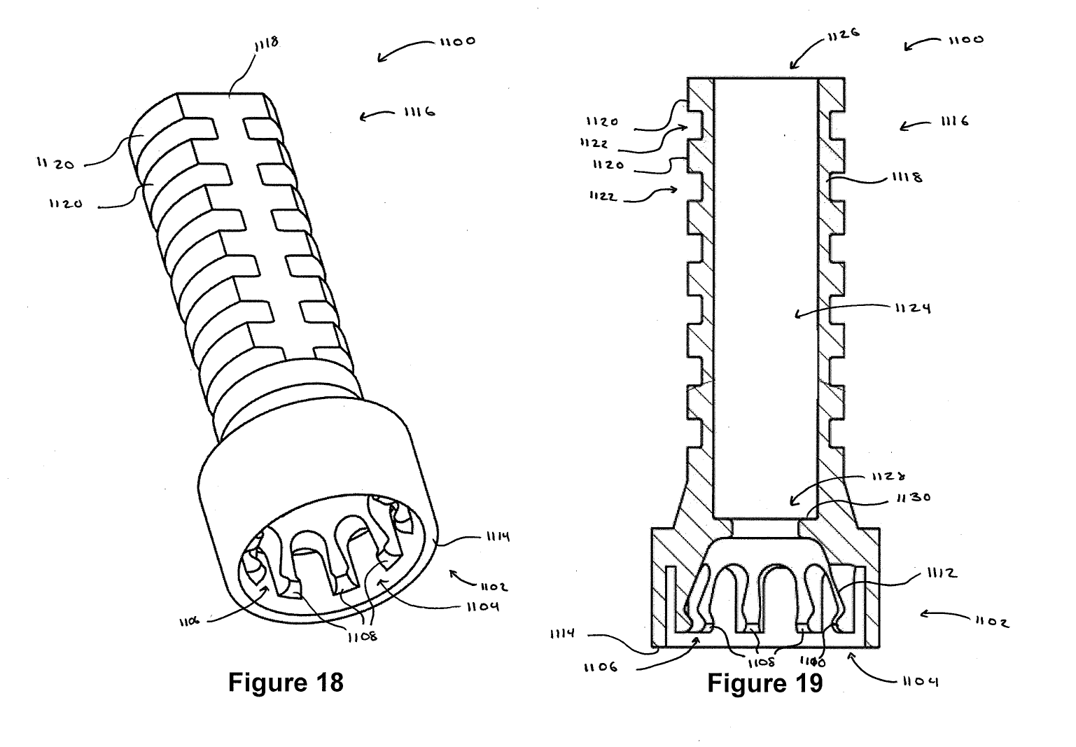

As shown in the illustrated embodiment, the abutment 1000 can include a recess or slot 1010, such as an annular slot, about a proximal portion 1004 of the abutment 1000. Similar to annular slot 652, slot 1010 can serve as a provisional connection feature between the abutment 1000 and a coping, such as coping 1050 described in connection with FIGS. 18 and 19. Other shapes, designs and features described in connection with abutment 800 can also be used with abutment 1000. For purposes of brevity, reference should be made to the discussion of abutment 800 for details regarding such structures. In some embodiments, the abutment 1000 can omit slot 1010.

The proximal portion 1004 can have a frustoconical shape which tapers towards the proximal end. A tapered portion 1012 can be designed to facilitate the placement of the coping over the abutment 1000 by providing a lead-in ramp for the coping's provisional connection feature, such as spring element 708 or other resilient element, designed to positively engage the slot 1010 of the abutment 1000. Of course, it should be understood that the proximal portion of the abutment 1000 can have any other type of shape as desired. Moreover, as shown in the illustrated embodiment, the abutment 1000 can include a keyed feature 1014. The keyed feature 1014 can be designed such that the component attached thereto, such as a coping, is properly aligned prior to coupling with the abutment 1000. This keyed feature 1014 can have, for example, a hexagonal cross section designed to engage a corresponding hexagonal recess in the coping. Other shapes can be used for keyed feature 1014 such as other types of polygons, lobular shapes such as trilobular and hexalobular shapes, elliptical shapes, and any other shape as desired. The keyed feature 1014 can also be used to engage a driving tool to rotate the abutment 1000 for purposes of coupling the abutment 1000 to an implant. In some embodiments, the keyed feature 1014 can include a chamfered or beveled proximal edge which can facilitate placement of the component over the keyed feature 1014.

In some embodiments, the proximal portion 1004 can include a flange forming a seat 1016. The seat 1016 can be designed to contact a portion of the coping upon the coping being coupled via a provisional connection feature, a prosthetic screw, or both. The seat 1016 can advantageously serve as a stop element for the coping (or other mating component) which can prevent or reduce the likelihood that a clinician overshoots insertion of the coping over the abutment 1000.

With reference now to FIGS. 18 and 19, an embodiment of a coping 1100 is illustrated which can have features similar to those described in connection with copings 130, 700, 850 and can be used with the various abutments described herein. As shown in the illustrated embodiment, the coping 1100 can include a distal portion 1102 having a cavity 1104 sized and shaped to receive at least some portion of the proximal portion of an abutment such as abutment 1000. The cavity 1104 can have a cylindrical shape or any other shape as desired. In some embodiments, the cavity 1104 can be sized and shaped to receive a keyed feature, such as keyed feature 1014, on the abutment 1000 to further ensure that the abutment 1000 and the coping 1100 are properly aligned and oriented prior to attachment.

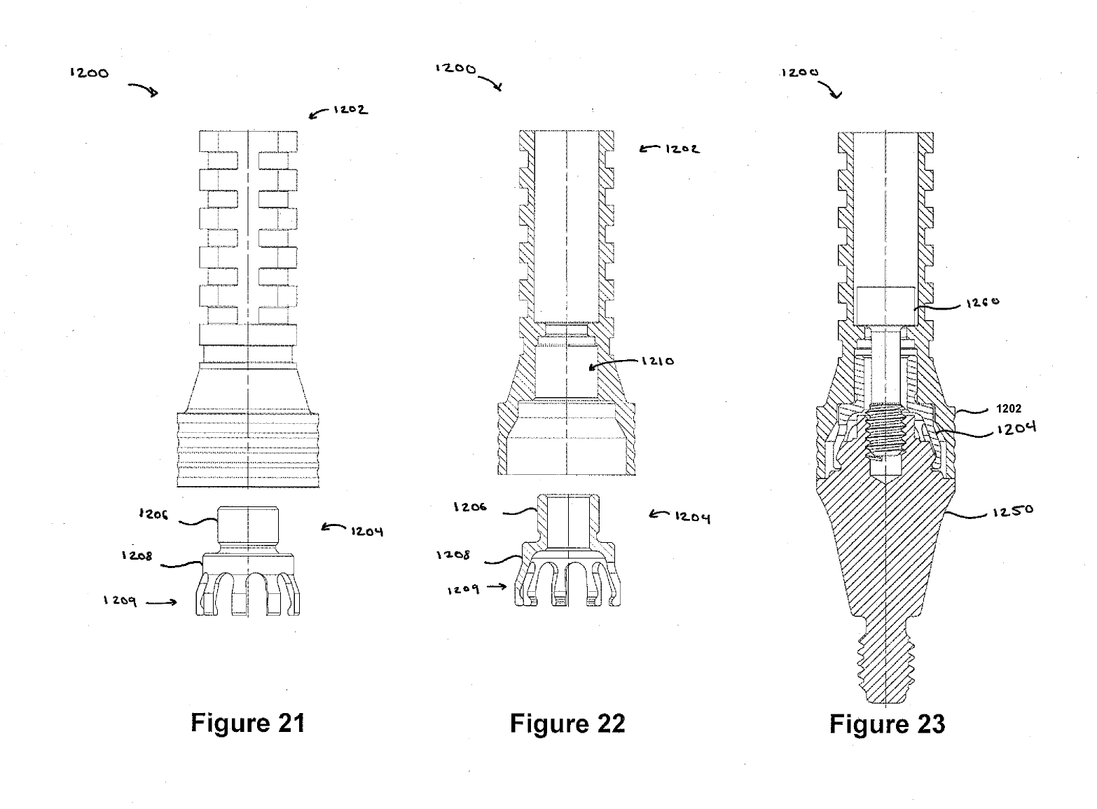

As shown in the illustrated embodiment, the coping 1100 can include a provisional connection feature 1106 integrally formed therein. As shown in the illustrated embodiment, the provisional connection feature 1106 can be in the form of one or more resilient elongate fingers 1108. The fingers 1108 can be designed to resiliently deform radially outward upon application of a force in that direction. The fingers 1108 can include an engagement protrusion 1110 sized and shaped to be received within a recess or slot, such as slot 1010, of the abutment 1000. The fingers 1108 can also have a tapered portion 1112. This tapered portion 1112 can be designed to abut the tapered portion 1012 of the abutment 1000 thereby enhancing stability of the coping 1100 with respect to the abutment 1000. Of course, other shapes and sizes for fingers 1108 can be used. For example, the coping 1100 can include an annular rib, protrusion, dimples or similar resilient features to interact with the slot 1010. Furthermore, the vertically oriented slots or protrusions can also be included along the interior surface of the cavity 1104. In some embodiments, the provisional connection feature 1106 can be separate from the remainder of the coping 1100 such as is shown in the embodiments of FIGS. 21-26. The provisional connection feature 1106 can be manufactured separately from the coping 1100 as one or more pieces which are later attached to the remainder of the coping 1100. In some embodiments, the provisional connection feature 1106 can be removably attached. In other embodiments, the provisional connection feature 1106 can be permanently attached.

The distal portion 1102 of the coping 1100 can include a distal surface 1114. For example, as shown in the illustrated embodiment, the distal surface 1114 can form an annular rim. The distal surface 1114 can contact the seat 1016 of the abutment 1000 when the coping 1100 is engaged to the abutment 1000. In some embodiments, contact between the seat 1016 and the surface 1114 can form a seal to prevent or reduce the likelihood of foreign matter entering into the cavity 1104.

The proximal portion 1116 of the coping 1100 can have a similar design to that of copings 130, 700, and 850. In some embodiments, the coping 1100 can include an elongate member 1118 extending in a longitudinal direction. The elongate member 1118 can include multiple projections 1120 or ribs which project radially outwardly from the elongate member 1118. The projections 1120 can be spaced apart to form annular slots 1122. As shown in the illustrated embodiment, protrusions 1120 can extend only partially around the elongate member 1118 and can extend only partially along the length of the elongate member 1118. Other structures as described herein can be also used for providing a similar benefit. For example, dimples or bosses can also be used with or without the protrusions 1120 and slots 1122. Furthermore, the surfaces of the coping 1100 can be roughened. In some embodiments, these protrusions 1120, slots 1122, dimples, and/or bosses can also be included on interior surfaces of the elongate member 1118 and therefore be located within a bore 1124.

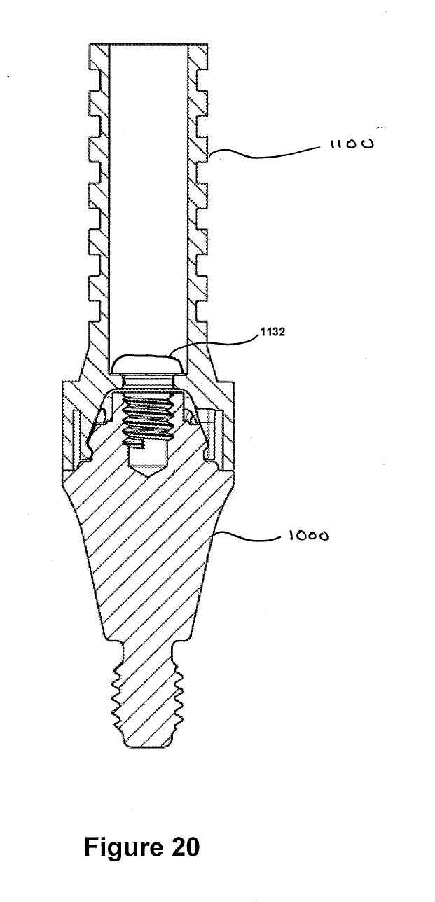

As shown in the illustrated embodiment, the elongate member 1118 can include a longitudinal bore 1124 through at least a portion of the elongate member 1118. As will be described in further detail below, this bore 1124 can be sized and shaped to allow a fastener to pass therethrough, similar to bores 139, 720. The bore 1124 can form an opening 1126 at a proximal end of the elongate member 1118. Of course, similar to other embodiments described herein, a plug, such as plug 722, to initially cover the opening 1126. At an opposite end of the bore 1124, the coping 1100 can include an aperture 1128 and a rim 1130, similar to aperture 724 and rim 726, designed to allow a fastener 1132 to pass therethrough and couple the coping 1100 to an abutment such as abutment 1000 as shown in FIG. 20.

With reference now to FIGS. 21-23, an embodiment of a coping 1200 is illustrated which can have features similar to those described in connection with copings 130, 700, 850, 1100 and can be used with the various abutments described herein. As shown in the illustrated embodiment, the coping 1200 can include a body component 1202 and a connector component 1204. As shown in the illustrated embodiment, the body component 1202 and the connector component 1204 can be two separate pieces which can advantageously facilitate manufacture of the coping 1200. The connector portion 1204 can be designed such that it can be removably attached to the body component 1202 or can be designed such that, once attached, the connector portion 1204 can be difficult to remove.

With continued reference to FIGS. 21-23, the connector component 1204 can include a head portion 1206 and a foot portion 1208. The foot portion 1208 can include a provisional connection feature such as resilient fingers 1209 similar to those of coping 1100. In some embodiments, the foot portion 1208 can include any other provisional connection feature including spring elements such as annular ring spring 730, wave spring 732, and any other provisional connection feature. The resilient fingers 1209 can be used to couple the coping 1200 to an abutment such as abutment 1250 or any other abutment such as abutments 120, 650, 800, 900. A connecting screw 1260 can be used to couple the coping 1200 to the abutment 1250.

The head portion 1206 can be sized to be received within a cavity 1210 of the body component 1202. In some embodiments, the head portion 1206 can have one or more cross-sectional dimensions equal to, or greater than, one or more cross-sectional dimensions of the cavity 1210. For example, in some embodiments, the cross-sections of the head portion 1206 and/or the cavity 1210 are circular and the head portion 1206 can have a diameter equal to, or greater than, the diameter of the cavity 1210. In this manner, the head portion 1206 and the cavity 1210 can be coupled via a friction fit or interference fit. In order to facilitate this friction fit, the top edge of the head portion 1206 can be beveled or tapered. In some embodiments, the head portion 1206 can have a cross-section less than that of the cavity 1210. In such an embodiment, as well as any other embodiment described herein, another fastening mechanism, such as an adhesive or fastener, can be used to couple the body component 1202 and the connector component 1204 together. The head portion 1206 can include a keyed feature which corresponds to a keyed feature of cavity 1210 which can facilitate proper orientation of the body component 1202 with the connector component 1204 in embodiments where there are one or more proper orientations. The engagement between the body component 1202 and the connector component 1204 can be chosen such that the force required to separate the two components 1202, 1204 is greater than the force required to separate the coping 1200 from the abutment, such as abutment 1250, to which it is attached.

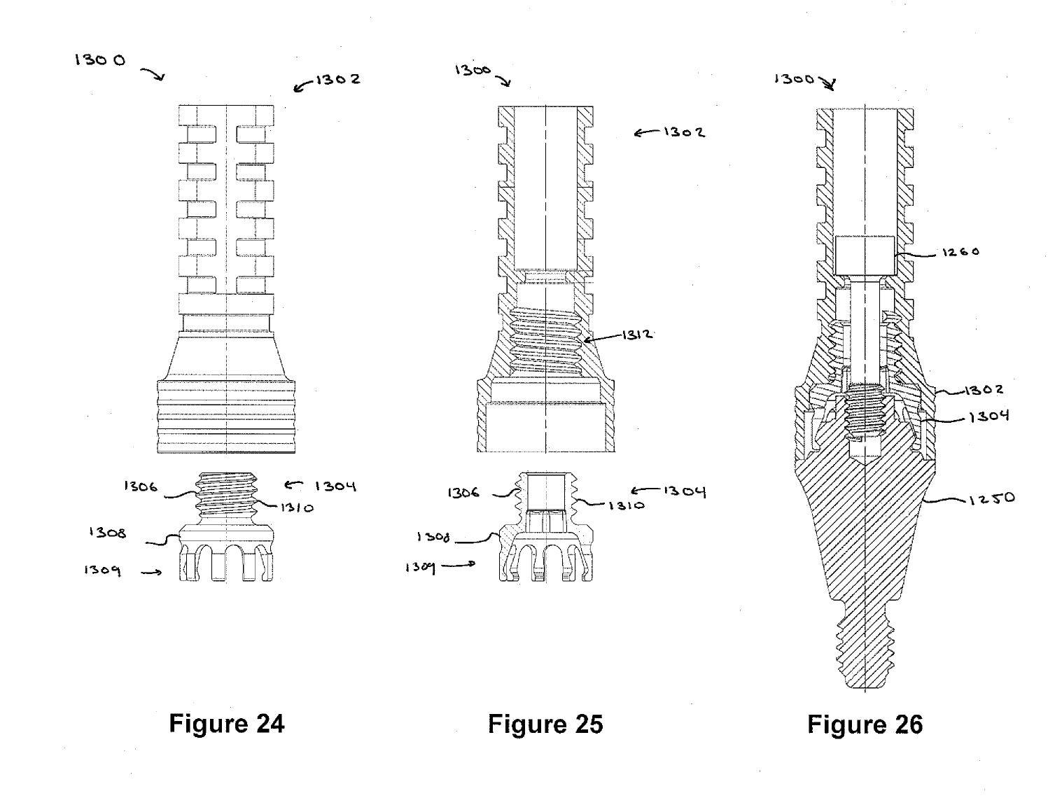

With reference now to FIGS. 24-26, an embodiment of a coping 1300 is illustrated which can have features similar to those described in connection with copings 130, 700, 850, 1100, 1200 and can be used with the various abutments described herein. Similar to coping 1200, the coping 1300 can include a body component 1302 and a connector component 1304. The connector component 1304 can include a head portion 1306 and a foot portion 1308. The foot portion 1308 can include a provisional connection feature such as resilient fingers 1309 similar to those of coping 1100, 1200. In some embodiments, the foot portion 1308 can include any other provisional connection feature including spring elements such as annular ring spring 730, wave spring 732, and any other provisional connection feature. The resilient fingers 1309 can be used to couple the coping 1300 to an abutment such as abutment 1250 or any other abutment such as abutments 120, 650, 800, 900. A connecting screw 1260 can be used to couple the coping 1300 to the abutment 1250. As shown in the illustrated embodiment, the head portion 1306 can include external threads 1310 which can engage corresponding internal threads 1312 of the body component 1302. In some embodiments, the head portion 1306 can include internal threads and the body component 1302 can include internal threading.

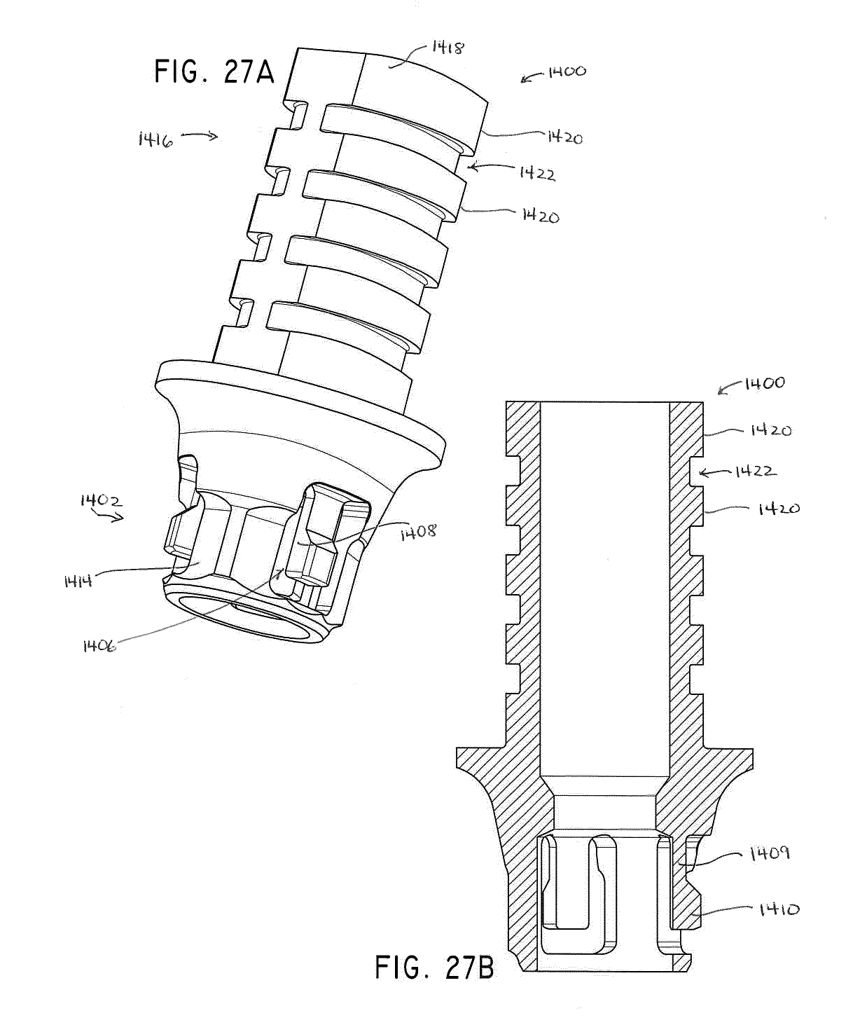

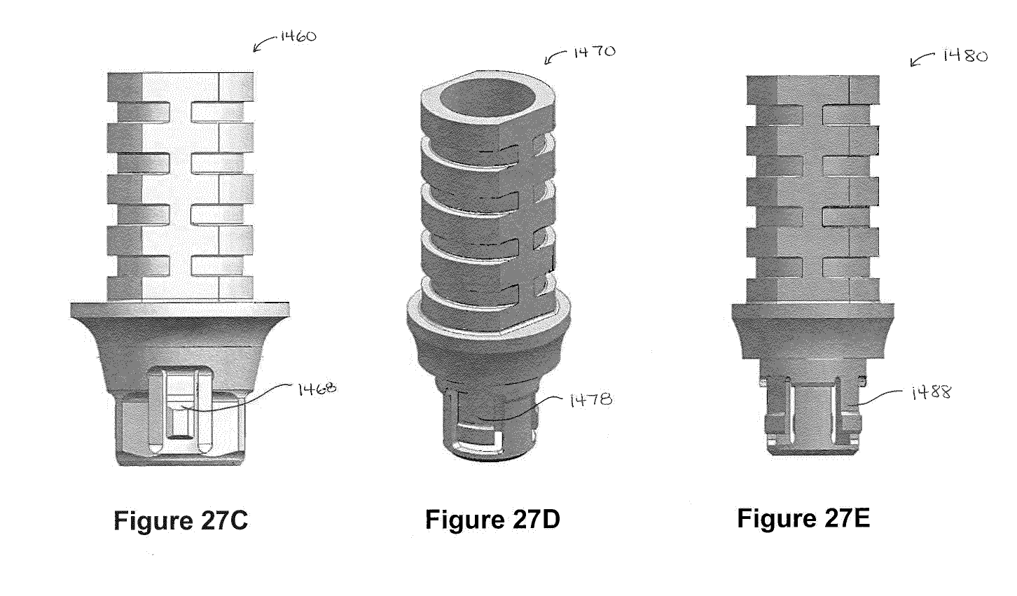

With reference now to FIGS. 27A and 27B, an embodiment of an abutment 1400 (e.g., a combined abutment and coping) is illustrated which can have any one or more of the features described herein with respect to other embodiments. As shown in the illustrated embodiment, the abutment 1400 can include a distal portion 1402 sized and shaped to be inserted into a recess, bore, or cavity of a proximal portion of an implant. The distal portion 1402 can include an annular surface 1414 and can have a cylindrical shape, a tapered shape, or any other shape as desired.

As shown in the illustrated embodiment, the abutment 1400 can include a provisional connection feature 1406. The provisional connection feature 1406 can be in the form of one or more elongate fingers 1408. The fingers 1408 can be similar to other fingers described herein. For example, the fingers 1408 can be resilient fingers. As shown in the illustrated embodiment, the fingers 1408 can include a straight portion 1409 and an engagement protrusion 1410. Of course, other shapes, sizes, and elements for the provisional connection feature 1406 can be used.

In various embodiments, the distal portion 1402 of the abutment 1400 can be used to mate with the proximal portion of an implant. In some such embodiments, the abutment 1400 can form a snap-fit connection with the implant via the provisional connection feature 1406. For example, one or more fingers 1408 can be resilient. One or more engagement protrusions 1410 of one or more fingers 1408 can snap-fit into a groove or similar feature of the implant. In some other embodiments, the abutment 1400 can form a friction fit connection with the implant via the provisional connection feature 1406. For example, one or more engagement protrusions 1410 of one or more fingers 1408 can press against an interior surface (e.g., an interior surface of a recess, bore, or cavity) of the implant.

In various embodiments, the proximal portion 1416 of the abutment 1400 can include an elongate member 1418 extending in a longitudinal direction as described herein with respect to other embodiments. For example, the elongate member 1418 can include multiple projections 1420 spaced apart to form annular slots 1422. The proximal portion 1416 and the distal portion 1402 can be formed integrally or manufactured separately. In some embodiments, the proximal portion 1416 and the distal portion 1402 are made with the same material(s), while in other embodiments, they are made with different materials. In one example, the distal portion 1402 including the fingers 1408 is made of a metal (e.g., titanium) and the proximal portion 1416 including the elongate member 1418 is made of a polymer (e.g., a PEEK material). In another example, the distal 1402 and proximal 1416 portions are both made of a metal (e.g., the same metal). In another example, the distal 1402 and proximal 1416 portions are both made of a polymer (e.g, the same polymer). In some embodiments, a portion of the distal portion 1402 can be made of a different material from another portion of the distal portion 1402. In some embodiments, a portion of the proximal portion 1416 can be made of a different material from another portion of the proximal portion 1402.

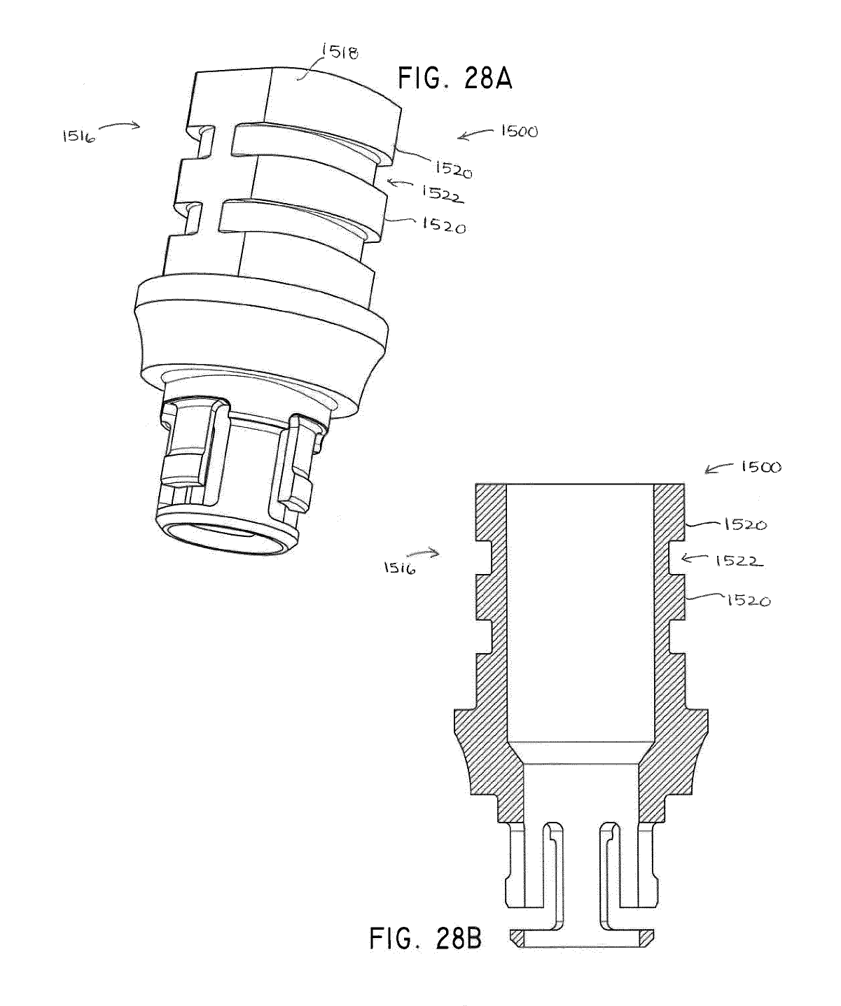

As described herein, features can vary in size, shape, and elements. For example, FIGS. 27C-27E illustrate other embodiments of an abutment (e.g., a combined abutment and coping) having a variation in the distal portion. In particular, compared to the embodiment shown in FIGS. 27A and 27B, the fingers 1468, 1478, 1488 in abutments 1460, 1470, 1480 respectively are different in size, shape, and location. Other examples are possible. FIGS. 28A and 28B illustrate another embodiment of an abutment (e.g., a combined abutment and coping) having a variation in the proximal portion. For example, the elongate member can vary in height, material, and color depending on the individual patient. As one example, the elongate member 1518 of the example abutment 1500 shown in FIGS. 28A and 28B is shorter than the elongate member 1418 of the example abutment 1400 shown in FIGS. 27A and 27B. In some embodiments, the elongate member can be about 30-50% shorter. In various embodiments, the elongate member can also be adjustable to accommodate the individual patient by removing material from the elongate member. By having a pre-shortened elongate member, time for intraoral adjustment can be reduced.

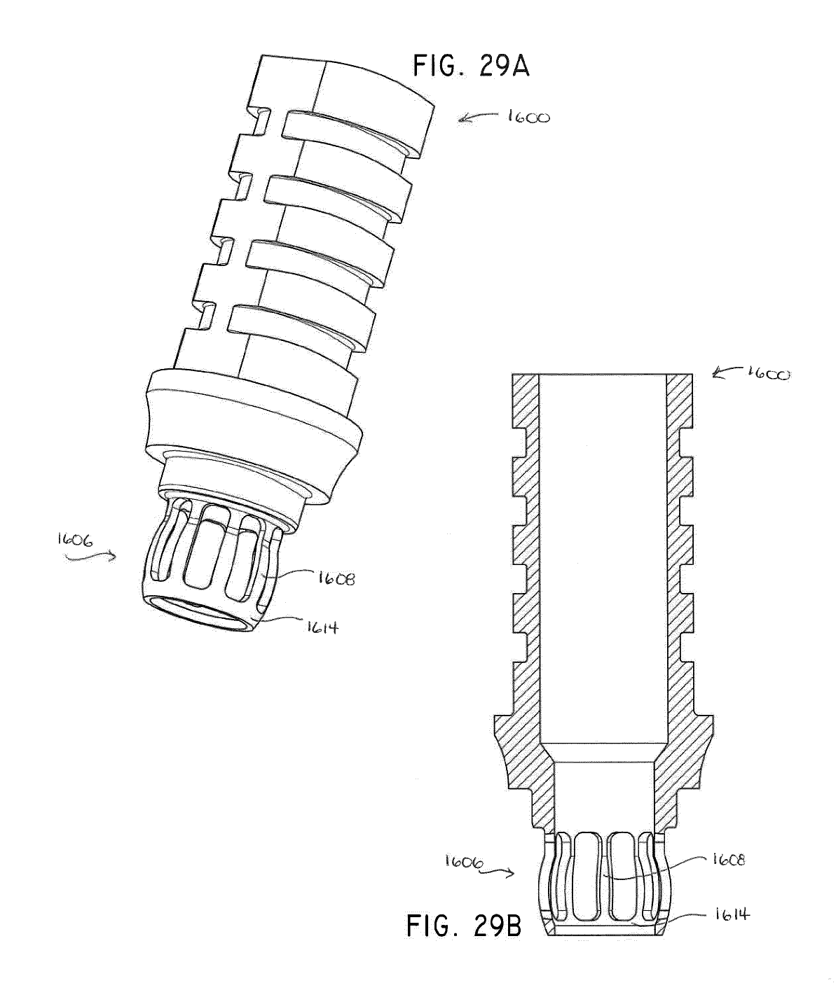

With reference now to FIGS. 29A and 29B, another embodiment of an abutment 1600 (e.g., a combined abutment and coping) is illustrated. As described herein, the abutment 1600 can vary in size shape, and elements. As shown in the illustrated embodiment, the abutment 1600 can include a provisional connectional feature 1606 comprising a plurality of spaced apart elongate elements 1608 coupled together by a circumferential rim 1614. In some embodiments, the elongate elements 1608 and/or the circumferential rim 1614 can be made of a resilient material. As another example, the circumferential rim 1614 can include a spring element (not shown), such as those described herein with respect to other embodiments. In various embodiments, the abutment 1600 can form a friction fit connection with an implant via the provisional connection feature 1606. For example, the elongate elements 1608 and/or the circumferential rim 1614 of the provisional connection feature 1606 of the abutment 1600 can press against an interior surface (e.g., of a recess, bore, or cavity) of the implant.

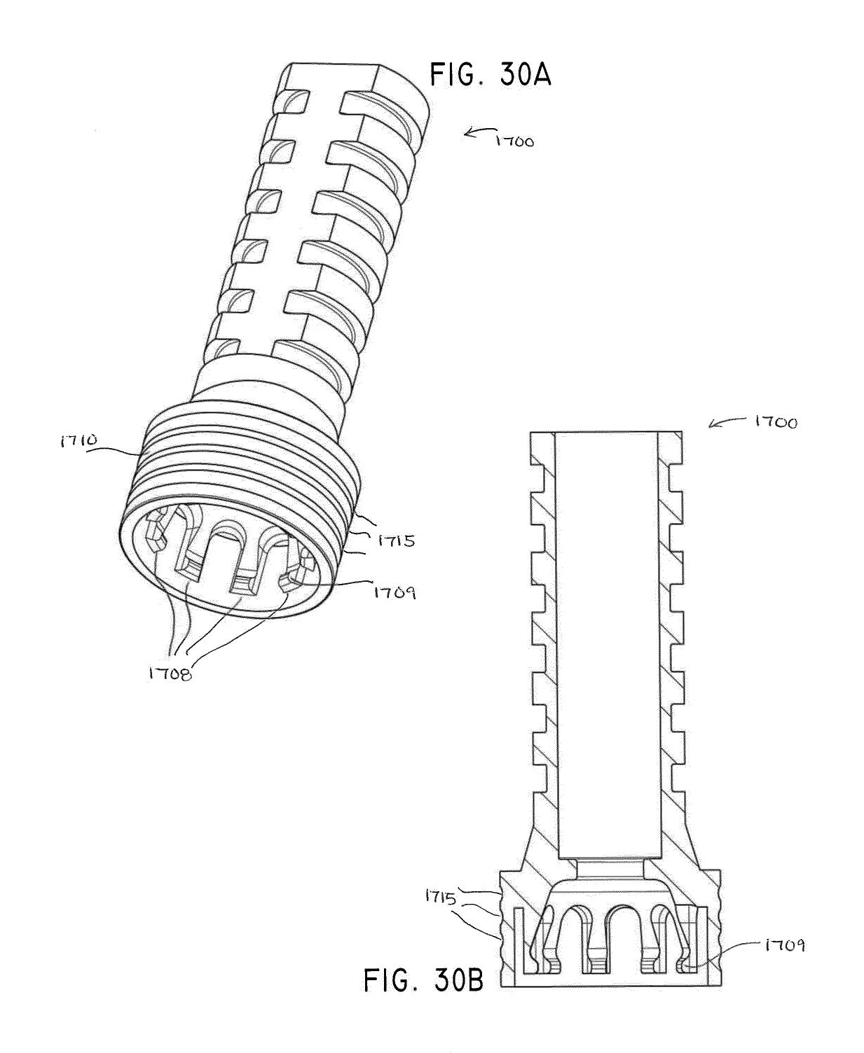

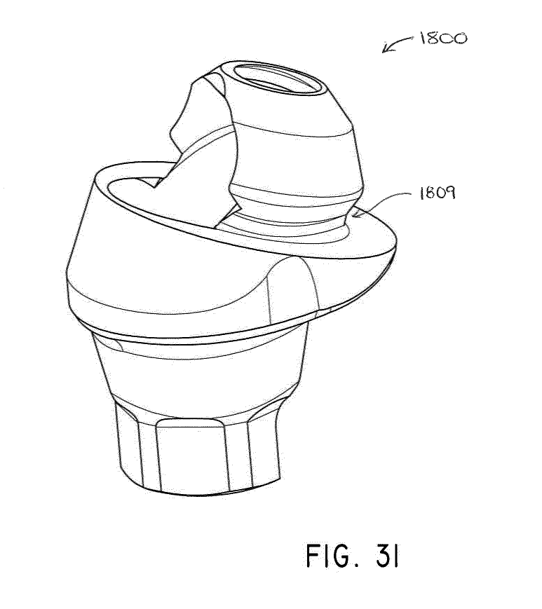

With reference now to FIGS. 30A and 30B, an example coping 1700 is illustrated. The coping 1700 can include any one or more features described herein with respect to other embodiments. As one example, the coping 1700 can include similar features as the example coping 1100 shown in FIGS. 18 and 19. As illustrated in FIGS. 30A and 30B, the coping 1700 can have a distal surface 1710 such as a flange or collar. However, compared to the coping 1100 shown in FIGS. 18 and 19, the distal surface 1710 of the coping 1700 can include features such as grooves 1715 (or protrusions and/or slots). In some embodiments, such features can facilitate the retention of a bonding agent or cement used when attaching (intra-orally or extra-orally) a crown or other restoration over the coping 1700. Furthermore, the coping 1700 can include fingers 1708 as described herein with respect to other embodiments (e.g., FIGS. 18 and 19). The fingers 1708 can include engagement protrusions 1709 sized and shaped to be received within a recess or slot of an abutment. For example, FIG. 31 shows an example abutment 1800 including a slot 1809 configured to receive the engagement protrusion 1709 of the coping 1700 shown in FIGS. 30A and 30B. The grooves 1715 can be used in combination with the embodiments described above (e.g., FIGS. 7A and 18) or as a separate independent feature.

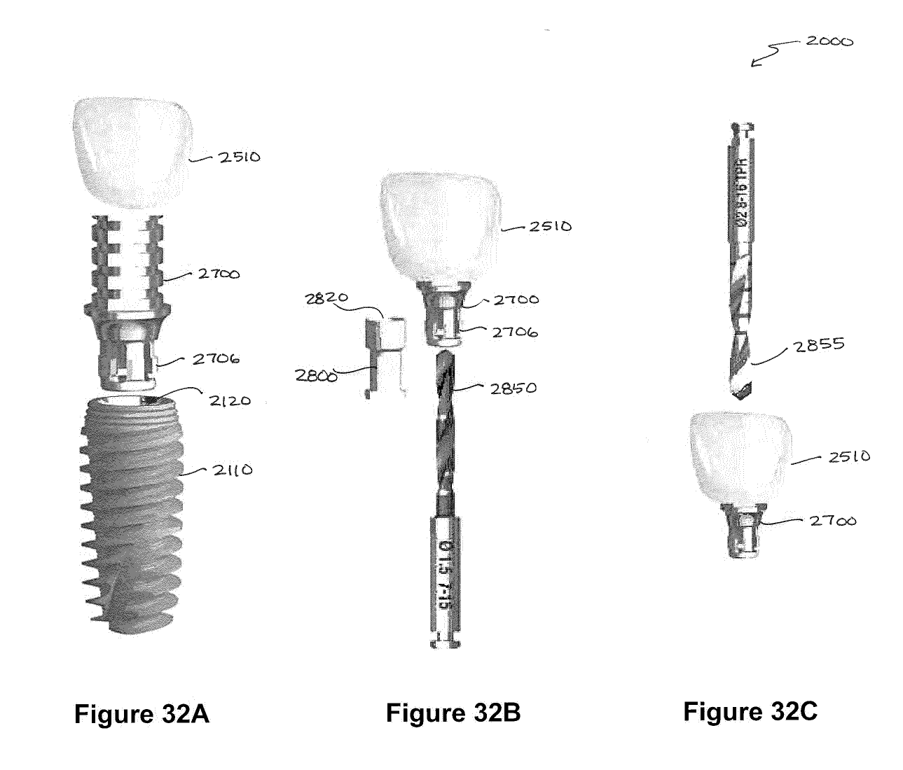

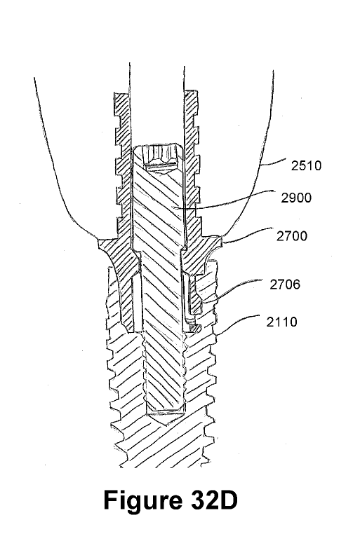

With reference now to FIGS. 32A-32C, an embodiment of a method 2000 is illustrated for coupling a dental prosthesis 2510 to a dental implant 2110. The method 2000 is an example of the method 300 described with reference to FIG. 3. For example, the dental implant 2110 can be coupled to a patient's bone (not shown) or in some instances, may not be coupled to a patient's bone (e.g., prepared at a laboratory). Of course, the dental implant 2110 shown in FIG. 32A is for illustrational purposes and it is understood that other types of dental implants can be used. For example, the example implant 2110 is shown as having a recess 2120 at the proximal end, while an implant with an external boss can also be contemplated.

As shown in FIG. 32A, the method 2000 can include coupling a dental component 2700 to the implant 2110. For illustrational purposes, FIG. 32A shows the dental component 2700 as the example abutment 1400 shown in FIGS. 27A-27B. However, the dental component 2700 can include any dental component having any of the various features (e.g., a provisional connection feature) described herein with respect to other embodiments. For example, the dental component 2700 can include any one or more copings, abutments, combined copings/abutments, or combinations thereof. In the case where multiple dental components are used (e.g., a multi-unit abutment or a coping used with an abutment), at least one of the dental components can include a provisional connection feature as described herein with respect to other embodiments.

A distal portion of the dental component 2700 can be coupled to a proximal portion of the implant 2110. In FIG. 32A, the dental component 2700 can be inserted into the recess 2120 of the implant 2110 and coupled together via the provisional connection feature 2706 of the dental component 2700. For example, the provisional connection feature 2706 can include a snap-fit, friction fit, or other provisional connection feature as disclosed herein.

The method 2000 can include bonding the prosthesis 2510 to the dental component 2700. The prosthesis 2510 is illustrated as a single tooth crown. In other embodiments, the prosthesis 2510 can be a multi-tooth restoration such as a partial or full bridge. As described herein, a bonding agent can be applied to the dental component 2700 and to the prosthesis 2510 and/or backfilling holes formed in the prosthesis 2510 with an acrylic, such as a self-curing acrylic or a light cured composite.

As shown in FIG. 32B, the bonded prosthesis 2510 and dental component 2700 can be decoupled from the implant 2110 via the provisional connection feature 2706. In instances where multiple dental components (e.g., a multi-unit abutment or a coping and an abutment) are used, at least one of the dental components can be decoupled from the implant 2110. For example, as shown in FIGS. 8-12, the coping 700 can be decoupled from the implant via the provisional connection feature (e.g., the retention spring 708), while the abutment 650 remains coupled to the implant.

With continued reference to FIG. 32B, the method 2000 can also include forming a through-hole (not shown) in both the decoupled dental component 2700 and the prosthesis 2510. For example, as described herein with respect to other embodiments, the through-hole can be created using a cutting tool 2850 (e.g., a drill bit) from a distal side of the dental component 2700. In some instances, an alignment tool (e.g., a drill guide) can be used to facilitate the alignment with the cutting tool 2850. For example, in some embodiments, the distal portion of the dental component 2700 can be coupled to at least the proximal portion of the alignment tool 2800. In some instances, the dental component 2700 can be inserted into a cavity 2820 of the alignment tool 2800 and coupled together via the provisional connection feature 2706 (e.g., snap-fit, friction fit, or other provisional connection feature) of the dental component 2700. However, in various embodiments, an alignment tool might not be needed. For example, the bore within the provisional connection feature 2706 and/or the decoupled dental component 2700 can, in some embodiments serve as an alignment tool. In some such embodiments, eliminating the steps of coupling and decoupling an alignment tool can simplify the procedure and reduce patient chairtime, In certain embodiments, after creating the through-hole through the prosthesis 2510 from the distal side (e.g., apical to occlusal), the cutting tool 2850 can reinforce the through-hole from a proximal side (e.g., occlusal to apical) of the prosthesis 2510. In some embodiments, as shown in FIG. 32C, after creating the through-hole through the prosthesis 2510 from the distal side (e.g., apical to occlusal), another cutting tool 2855 (e.g., having a different diameter such as a larger diameter than the cutting tool 2850 creating the original through-hole) can enlargen the through-hole from a proximal side (e.g., occlusal to apical) of the prosthesis 2510. As described herein, this hole can have a greater diameter than the original through-hole. For example, the cutting tool 2850 creating the original through-hole can have a cutting diameter of about 1.5 mm, while the other cutting tool 2855 can have a cutting diameter of about 2.0 mm. The cutting diameters can be based on the size of the prosthesis, dental components, implant, and/or fasteners, and are not particularly limited. This step can be performed when a fastener being used is larger than the original through-hole. The method 2000 can further include recoupling the dental component 2700 and the prosthesis 2510 to the implant 2110. As shown in FIG. 32D, a fastener (e.g., a screw) 2900 can be inserted into the through-hole to couple the prosthesis 2510 to the implant 2110.

Certain embodiments of systems and methods can provide an efficient workflow execution post-surgery, which can reduce the risk of site contamination and extensive tissue swelling, thus reducing healing time. For example, systems and methods using a provisional connection feature as described herein can reduce (e.g., substantially eliminate) the use of screwing and unscrewing components in patients which takes chairtime. In addition, certain embodiments described herein can provide a screw access hole which is easy to locate, but not too large.

As described herein, e.g., with reference to FIG. 1, in various embodiments, a dental implant 110 can have a distal end 112 designed to be placed within a patient's jaw and a proximal end 114 designed to allow attachment of another dental component such as the abutment 120, the coping 130, or the combined coping 130/abutment 120. The dental component is not particularly limited. For example, the dental component can include an adapter.

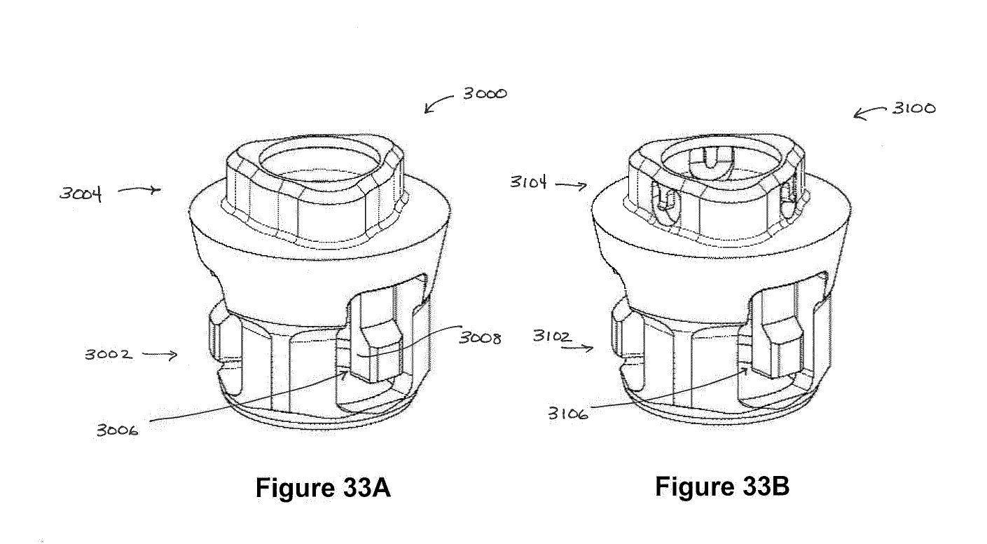

With reference now to FIG. 33A, an embodiment of an adapter 3000 is illustrated which can have any one or more of the features described herein with respect to other embodiments. For example, the adapter 3000 can have a distal portion 3002, a proximal portion 3004, or both a distal portion 3002 and a proximal portion 3004 having a provisional connection feature. In the illustrated embodiment, the adapter 3000 has a distal portion 3002 having a provisional connection feature 3006. The provisional connection feature 3006 can be in the form of any of the provisional connection features described herein. In the illustrated embodiment, the provisional connection feature 3006 includes elongate fingers 3008 similar to other fingers described herein. Of course, as described herein, other shapes, sizes, and elements (e.g., springs) for the provisional connection feature 3008 can be used. Furthermore, the material or materials of the adapter 3000 are not particularly limited and can include those described herein for other components. For example, the adapter 3000 can be made of a metal.

In various embodiments, the distal portion 3002 of the adapter 3000 can be used to mate with the proximal portion of an implant. In some such embodiments, the adapter 3000 can form a snap-fit and/or a friction fit connection (as described herein with respect to other embodiments) with the implant via the provisional connection feature 3006. The implant is not particularly limited and can include a conical connection, a tri-lobe connection, a hexagonal connection, etc. Advantageously, certain embodiments of the adapter 3000 having a provisional connection feature 3006 can provide a system that is relatively easy to use (e.g., having less parts such as less screws).

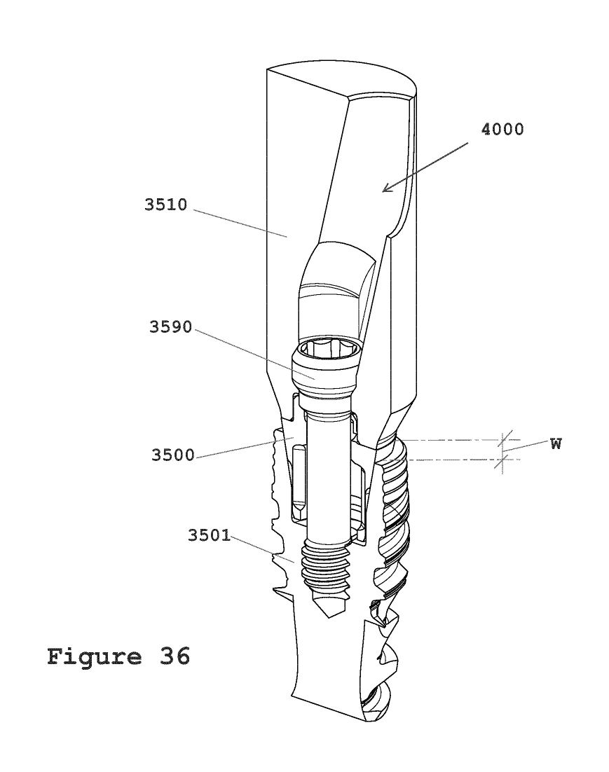

In various embodiments, the adapter 3000 can be configured to be coupled to one or more other dental components, e.g., on a side opposite the implant. For example, the adapter 3000 can be designed to have a proximal portion 3004 (e.g., a conical connection, a tri-lobe connection, a hexagonal connection, etc.) configured to be coupled to a variety of components (e.g., a prosthesis such as a single or multi-tooth restoration, an abutment, an impression component such as an impression post, a healing cap, scan body etc.). The components that can be used are not particularly limited and can include standard, temporary or customer made (CAD/CAM) components. In some embodiments, the components can have a provisional connection feature configured to mate with the adapter 3000 via a snap-fit and/or a friction fit connection. In some embodiments, the components can have an angulated screw channel. In some embodiment, at least a portion of an adapter is designed to face soft tissue when the adapter is coupled with the dental implant. During a healing phase, the soft tissue can adhere to said portion of the adapter. In some embodiments the portion facing the soft tissue has a width “w” measured along a vertical axis of the adapter of at least 4 mm (see FIG. 36). Advantageously, certain adapters 3000 can remain coupled with the implant, e.g., during the impression and/or healing period, for better soft tissue management and can allow for use of a variety of components. In other words, the adapter may act as a platform that remains coupled to the implant and at least partially contacting the soft tissue to which other dental component can be connected. This avoids destruction of the adhesion between the adapter and the soft tissue that is created during healing of the soft tissue and result in better soft tissue management.

FIG. 33B illustrates an embodiment of an adapter 3100 including a proximal portion 3104 having a provisional connection feature 3010 configured to mate with one or more dental components. The illustrated provisional connection feature 3010 includes a slot, e.g., configured to mate with a corresponding snap-fit element. However, of course, as described herein, other provisional connection features can be used.

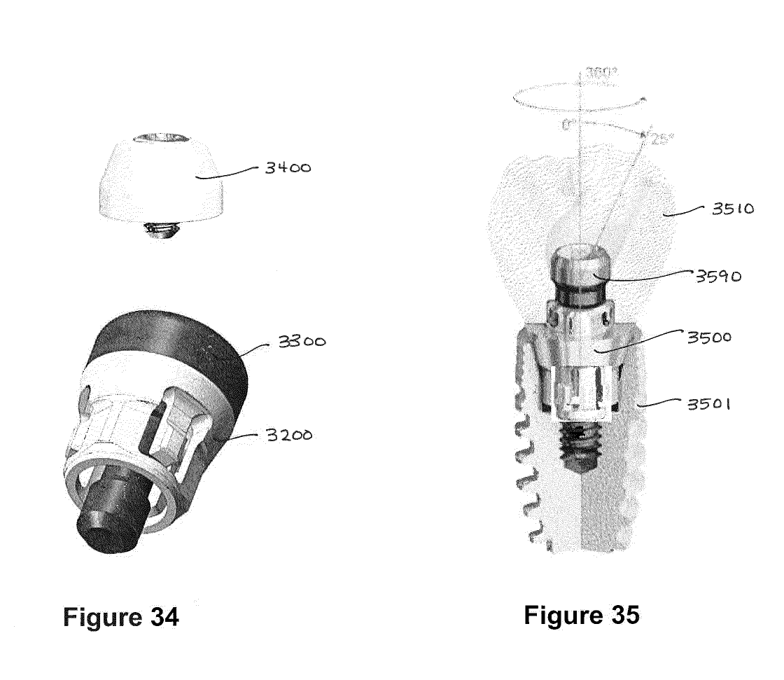

FIGS. 34, 35 and 36 illustrate example components that can be coupled to an adapter. For example, as shown in FIG. 34, after the implant (not shown) is placed within a patient's jaw, an adapter 3200 coupled with an impression component 3300 (e.g., an open or closed tray impression post) can be mounted on the implant. The upper part of the impression post can remain in impression material and can act as a connection member for the implant replica. Alternatively, the impression post can act as an intra-oral scan post. As another example, the adapter 3200 coupled with a healing cap 3400, can be mounted on the implant. The impression can be taken on the healing cap 3400 and scanned with a desktop or intra-oral scanner on the healing cap 3400. Other examples are possible, for example, the adapter can be mounted on the implant, and a temporary, a standard or a individualized (CAD/CAM) abutment can be coupled with the adapter. FIGS. 35 and 36 illustrates yet another example embodiment. The adapter 3500 can be mounted on the implant 3501. A prosthesis 3510 (only partially shown on FIG. 36) can be coupled to the adapter 3500 by a fastener 3590. In some embodiments, the prosthesis 3510 can include an angulated screw channel 4000 (e.g., up to about 25 degrees from the axis of the implant 3501) for receiving the fastener 3590. It should be appreciated that the adapter can be configured to couple with various designs of dental components and various materials of dental components (e.g., dental components made of titanium, titanium alloy, PEEK, zirconia, gold, CoCr, etc.). In certain embodiments, the adapter can be used to create a “tissue level implant”. Once placed, the adapter is normally not removed and other dental components can therefore be connected to the adapter at its proximal (coronal) end. This can be done for example by using a screw passing through the adapter and received within a socket of the implant. Therefore, the adapter is provided with a friction fit retention connection allowing connection to the implant, but also allowing disconnection of the adapter to the implant in case of need.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

### LISTING OF EMBODIMENTS

1. A system for coupling a dental component to a dental implant, the device comprising:
a coping comprising a provisional connection feature.

2. The system of Embodiment 1, further comprising:
an abutment comprising a provisional connection feature and a second connection feature;
wherein the coping and the abutment are configured to be temporarily coupled together via the provisional connection feature; and
wherein the abutment is configured to be coupled to the implant.

3. The system of Embodiment 2, further comprising a fastener comprising threading, the threading configured to engage the second connection feature to couple the coping with the abutment.

4. The system of any of Embodiments 1-3, wherein the coping further comprises an elongate member, the elongate member comprising a plurality of protrusions and slots.

5. The system of any of Embodiments 1-4, wherein the provisional connection feature of the coping comprises a resilient member.

6. The system of Embodiment 5, wherein the resilient member comprises a wave spring.

7. The system of Embodiment 6, wherein the wave spring is received within a slot of the provisional coping.

8. The system of Embodiment 5, wherein the provisional connection feature of the coping comprises one or more resilient fingers.

9. The system of any of Embodiments 1-8, wherein the coping comprises a body component and a connector component, wherein the connector component comprises the provisional connection feature of the coping.

10. The system of Embodiment 9, wherein the body component comprises the elongate member.

11. The system of any of Embodiments 9 or 10, wherein the body component and the connector component are configured to be coupled together.

12. The system of Embodiment 11, wherein the body component and the connector component are configured to be coupled via a friction fit.

13. The system of Embodiment 11, wherein the connector component comprises threading configured to engage corresponding threading on the body component.

14. The system of any of Embodiments 1-13, further comprising a cutting tool.

15. The system of Embodiment 14, further comprising an alignment tool configured to be removably coupled to the coping via the provisional connection feature of the coping.

16. The system of Embodiment 15, the alignment tool further comprising an alignment feature through which the cutting tool can pass.

17. A method of coupling a dental prosthesis to an implant and an abutment in a patient's jaw, the method comprising:

coupling a coping to the abutment using a snap-fit connection;
bonding the prosthesis to the coping;
decoupling the prosthesis and coping from the abutment via the snap-fit connection,
forming a through-hole in both the coping and the prosthesis; and
coupling the coping and prosthesis to the abutment using a fastener inserted into the through-hole.

18. A method of coupling a dental prosthesis to an implant and an abutment in a patient's jaw, the method comprising:
temporarily coupling a coping to the abutment via a provisional connection feature;
modifying the alignment between the prosthesis and coping and coupling the prosthesis to the coping;
removing the prosthesis and coping from the abutment such that the prosthesis and coping remain in the modified alignment.

19. The method of Embodiment 18, further comprising forming a hole through at least the prosthesis using a cutting tool.

20. The method of Embodiment 19, wherein the step of forming a hole through at least the prosthesis comprises attaching an alignment tool to the coping and using the alignment tool to align the cutting tool with respect to the prosthesis.

21. The method of any of Embodiments 18 or 19, further comprising coupling the coping to the abutment via a second connection feature, the second connection feature being different from the provisional connection feature.

22. The method of Embodiment 21, wherein the step of coupling the coping to the abutment via a second connection feature comprises fastening the coping to the abutment using a threaded fastener.

23. The method of any of Embodiments 18-22, wherein the step of temporarily coupling the coping to the abutment via a provisional connection feature comprises engaging a snap fit connection feature on the coping with a corresponding snap fit connection feature on the abutment.

24. The method of any of Embodiments 18-23, wherein the step of coupling the prosthesis to the coping comprises applying a bonding agent to the coping and to the prosthesis.

25. The method of Embodiment 24, wherein the prosthesis comprises one or more blind holes and the step of applying the bonding agent to the prosthesis comprising introducing the bonding against into the one or more blind holes.

26. The method of any of Embodiments 18-25, wherein the step of modifying the alignment between the prosthesis and coping comprises orienting occlusal surfaces and establishing vertical dimension of the prosthesis with occlusal surfaces of opposing dentition.

27. The method of any of Embodiments 18-26, further comprising determining a preliminary fit of the prosthesis with respect to the coping prior to the step of attaching the prosthesis to the coping.

28. The method of Embodiment 27, further comprising modifying the coping to alter the fit of the prosthesis with respect to the coping.

29. A method of attaching and aligning a dental prosthesis to an abutment and coping in a patient's jaw, the method comprising:
coupling the coping to the abutment via a provisional connection feature;
bonding the prosthesis to the coping;
modifying the alignment between the prosthesis and the coping while the prosthesis is being bonded to the coping;
removing the prosthesis and coping from the abutment.

30. The method of Embodiment 29, further comprising forming one or more blind holes in the prosthesis and the step of bonding the prosthesis to the coping comprises bonding the coping within the one or more blind holes.

31. The method of Embodiment 29, further comprising forming a hole through the prosthesis using a cutting tool.

32. The method of Embodiment 31, wherein the step of forming a hole through the prosthesis comprises attaching an alignment tool to the coping and using the alignment tool to align the cutting tool with respect to the prosthesis.

33. The method of Embodiment 31, further comprising coupling the coping to the abutment using a threaded fastener.

34. The method of Embodiment 29, wherein the step of modifying the alignment between the prosthesis and coping comprises placing occlusal surfaces of the prosthesis in contact with occlusal surfaces of opposing dentition.

35. A system for coupling one or more dental components to a dental implant, the system comprising:
at least one dental component of the one or more dental components comprising a provisional connection feature.

36. The system of Embodiment 35, wherein the at least one dental component comprises an abutment configured to couple with the dental implant via the provisional connection feature.

37. The system of Embodiment 36, wherein the abutment comprises an abutment integrated with a coping.

38. The system of Embodiment 36, wherein the provisional connection feature of the abutment comprises one or more fingers.

39. The system of Embodiment 36, wherein the provisional connection feature of the abutment comprises a spring.

40. The system of Embodiment 36, wherein the abutment and the implant are configured to be coupled via a snap-fit.

41. The system of Embodiment 36, wherein the abutment and the implant are configured to be coupled via a friction fit.

42. The system of Embodiment 35, wherein the one or more dental components comprise a coping and an abutment,
wherein the at least one dental component comprises the coping configured to couple with the abutment via the provisional connection feature, or
wherein the at least one dental component comprises the abutment configured to couple with the coping via the provisional connection feature.

43. The system of Embodiment 42, wherein the abutment comprises a second connection feature, and the abutment is configured to be coupled to the implant via the second connection feature.

44. The system of Embodiment 42, wherein the provisional connection feature comprises one or more fingers.

45. The system of Embodiment 42, wherein the provisional connection feature comprises a spring.

46. The system of Embodiment 42, wherein the coping and the abutment are configured to be coupled via a snap-fit.

47. The system of Embodiment 42, wherein the coping and the abutment are configured to be coupled via a friction fit.

48. The system of Embodiment 42, wherein the coping comprises an elongate member, the elongate member comprising a plurality of protrusions and slots.

49. The system of Embodiment 42, wherein the coping comprises a flange, the flange comprising a plurality of grooves.

50. The system of Embodiment 35, further comprising a cutting tool.

51. The system of Embodiment 35, wherein the at least one dental component comprises an adapter configured to couple with the dental implant via the provisional connection feature.

52. The system of Embodiment 51, wherein the provisional connection feature comprises one or more fingers.

53. The system of Embodiment 51, wherein the provisional connection feature comprises a spring.

54. The system of Embodiment 51, wherein the adapter and the implant are configured to be coupled via a snap-fit.

55. The system of Embodiment 51, wherein the adapter and the implant are configured to be coupled via a friction fit.

56. The system of Embodiment 51, wherein the adapter is configured to be coupled to one or more other dental components on a side opposite the dental implant.

57. The system of Embodiment 56, wherein the one or more other dental components comprise at least one of a prosthesis, an abutment, an impression post, and a healing cap.

58. The system of Embodiment 57, wherein the one or more other dental components comprise an angulated screw channel.

59. A method of creating a dental prosthesis configured to be coupled to a dental implant, the method comprising:
coupling one or more dental components to the implant, at least one dental component of the one or more dental components having a provisional connection feature;
bonding the prosthesis to the one or more dental components;
decoupling the prosthesis and the at least one dental component from the implant via the provisional connection feature; and
forming a through-hole in both the at least one dental component and the prosthesis, wherein the through-hole is configured to receive a fastener configured to couple with the prosthesis and the at least one dental component to the dental implant.

60. The method of Embodiment 59, wherein forming the through-hole comprises forming the through-hole using a cutting tool from a distal side of the at least one dental component.

61. The method of Embodiment 60, wherein forming the through-hole further comprises forming the through-hole using the cutting tool or another cutting tool from an occlusal side of the prosthesis.

62. The method of Embodiment 59, further comprising coupling the at least one dental component and the prosthesis to the implant using the fastener inserted into the through-hole.

63. The method of Embodiment 59, wherein the provisional connection feature comprises a snap-fit connection feature.

64. The method of Embodiment 59, wherein the provisional connection feature comprises a friction fit connection feature.

65. The method of Embodiment 59, wherein the at least one dental component comprises an abutment configured to couple with the implant via the provisional connection feature.

66. The method of Embodiment 65, wherein the abutment comprises an abutment integrated with a coping.

67. The method of Embodiment 59, wherein the one or more dental components comprise a coping and an abutment,
wherein the at least one dental component comprises the coping configured to couple with the abutment via the provisional connection feature, or
wherein the at least one dental component comprises the abutment configured to couple with the coping via the provisional connection feature.

68. The method of Embodiment 67, wherein the abutment comprises a second connection feature, and the abutment is configured to be coupled to the implant via the second connection feature.

69. A Method of creating a dental restoration comprising:
a) coupling a first dental components, such as an adapter to a dental implant installed in a jaw bone using a snap fit and/or a friction fit connection such that at least a portion of said first dental component faces soft tissue, said first dental component being designed not to be removed from the dental implant;
b) coupling at least another dental component to said first dental component.

70. The method of embodiment 69 wherein coupling another dental component comprises coupling a healing abutment, an impression component or an intra-oral scan post a to the first dental component.

71. The method of embodiment 69 wherein coupling another dental component comprises coupling a prosthesis including an angulated screw channel to the first dental component using a fastener.

1. A system for coupling a dental component to a dental implant, the device comprising:
a coping comprising a provisional connection feature; and
an alignment tool configured to be removably coupled to the coping via the provisional connection feature of the coping, the alignment tool comprising an alignment feature through which the cutting tool can pass.

2. The system of claim 1, further comprising:
an abutment comprising a provisional connection feature and a second connection feature;
wherein the coping and the abutment are configured to be temporarily coupled together via the provisional connection feature; and
wherein the abutment is configured to be coupled to the implant.

3. The system of claim 2, further comprising a fastener comprising threading, the threading configured to engage the second connection feature to couple the coping with the abutment.

4. The system of claim 1, wherein the coping further comprises an elongate member, the elongate member comprising a plurality of protrusions and slots.

5. The system of claim 1, wherein the provisional connection feature of the coping comprises a resilient member.

6. (canceled)

7. (canceled)

8. (canceled)

9. The system of claim 1, wherein the coping comprises a body component and a connector component, wherein the connector component comprises the provisional connection feature of the coping.

10. (canceled)

11. (canceled)

12. (canceled)

13. (canceled)

14. The system of claim 1, further comprising a cutting tool.

15. (canceled)

16. (canceled)

17. A method of coupling a dental prosthesis to an implant and an abutment in a patient's jaw, the method comprising:
coupling a coping to the abutment using a snap-fit connection;
bonding the prosthesis to the coping;
decoupling the prosthesis and coping from the abutment via the snap-fit connection,
forming a through-hole in both the coping and the prosthesis; and
coupling the coping and prosthesis to the abutment using a fastener inserted into the through-hole.

18. A method of coupling a dental prosthesis to an implant and an abutment in a patient's jaw, the method comprising:
temporarily coupling a coping to the abutment via a provisional connection feature;
modifying the alignment between the prosthesis and coping and coupling the prosthesis to the coping;
removing the prosthesis and coping from the abutment such that the prosthesis and coping remain in the modified alignment; and
forming a hole through at least the prosthesis using a cutting tool.

19. (canceled)

20. The method of claim 19, wherein the step of forming a hole through at least the prosthesis comprises attaching an alignment tool to the coping and using the alignment tool to align the cutting tool with respect to the prosthesis.

21. The method of claim 18, further comprising coupling the coping to the abutment via a second connection feature, the second connection feature being different from the provisional connection feature.

22. (canceled)

23. The method of claim 18, wherein the step of temporarily coupling the coping to the abutment via a provisional connection feature comprises engaging a snap fit connection feature on the coping with a corresponding snap fit connection feature on the abutment.

24. The method of claim 18, wherein the step of coupling the prosthesis to the coping comprises applying a bonding agent to the coping and to the prosthesis.

25. (canceled)

26. The method of claim 18, wherein the step of modifying the alignment between the prosthesis and coping comprises orienting occlusal surfaces and establishing vertical dimension of the prosthesis with occlusal surfaces of opposing dentition.

27. The method of claim 18, further comprising determining a preliminary fit of the prosthesis with respect to the coping prior to the step of attaching the prosthesis to the coping.

28. The method of claim 27, further comprising modifying the coping to alter the fit of the prosthesis with respect to the coping.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A method of creating a dental prosthesis configured to be coupled to a dental implant, the method comprising:
coupling one or more dental components to the implant, at least one dental component of the one or more dental components having a provisional connection feature;
bonding the prosthesis to the one or more dental components;
decoupling the prosthesis and the at least one dental component from the implant via the provisional connection feature; and
forming a through-hole in both the at least one dental component and the prosthesis, wherein the through-hole is configured to receive a fastener configured to couple with the prosthesis and the at least one dental component to the dental implant.

60. The method of claim 59, wherein forming the through-hole comprises forming the through-hole using a cutting tool from a distal side of the at least one dental component.

61. The method of claim 60, wherein forming the through-hole further comprises forming the through-hole using the cutting tool or another cutting tool from an occlusal side of the prosthesis.

62. The method of claim 59, further comprising coupling the at least one dental component and the prosthesis to the implant using the fastener inserted into the through-hole.

63. The method of claim 59, wherein the provisional connection feature comprises a snap-fit connection feature.

64. The method of claim 59, wherein the provisional connection feature comprises a friction fit connection feature.

65. The method of claim 59, wherein the at least one dental component comprises an abutment configured to couple with the implant via the provisional connection feature.

66. (canceled)

67. The method of claim 59, wherein the one or more dental components comprise a coping and an abutment,
wherein the at least one dental component comprises the coping configured to couple with the abutment via the provisional connection feature, or
wherein the at least one dental component comprises the abutment configured to couple with the coping via the provisional connection feature.

68. The method of claim 67, wherein the abutment comprises a second connection feature, and the abutment is configured to be coupled to the implant via the second connection feature.

69. (canceled)

70. (canceled)

71. (canceled)
